(19) United States
(12) Patent Application Publication
(10) Pub. No.: US 2017/0002477 A1
(43) Pub. Date: Jan. 5, 2017

(54) DECORATIVE PLATED PRODUCT, FITTING STRUCTURE, PRODUCTION METHOD AND FITTING METHOD

(71) Applicant: TOYODA GOSEI CO., LTD., Kiyosu-shi (JP)

(72) Inventors: Yoshinori YOSHIZAWA, Kiyosu-shi (JP); Hiroaki ANDO, Kiyosu-shi (JP); Tsuyoshi SUZUKI, Kiyosu-shi (JP); Takayasu IDO, Kiyosu-shi (JP)

(21) Appl. No.: 15/113,467

(22) PCT Filed: Sep. 11, 2015
(86) PCT No.: PCT/JP2015/075886

§ 371 Date: Jul. 22, 2016

(30) Foreign Application Priority Data
Sep. 29, 2014 (JP) 2014-199144
Oct. 20, 2014 (JP) 2014-213943
Oct. 23, 2014 (JP) 2014-216182
Oct. 23, 2014 (JP) 2014-216443

(51) Int. Cl. C25D 13/06; C25D 13/12; C09D 5/08; C23C 18/16; C23C 28/02; C09D 5/44; C25D 5/48; C23C 18/32

(52) U.S. Cl. CPC C25D 13/06; C25D 5/48; C25D 13/12; C23C 18/32; C23C 18/1653; C23C 18/1641; C23C 18/1605; C23C 28/023; C09D 5/4411; C09D 5/08; B60R 13/04

(57) ABSTRACT

A decorative plated product includes: a base comprising contact parts having shapes that are engageable with metal fitting members; a plating layer that covers the base; and a synthetic resin layer that covers at least portions of the plating layer over the contact parts.

### TECHNICAL FIELD

The present invention relates to an ornamental plated product including a plating layer that covers a base.

### BACKGROUND ART

Plating is a surface processing technique typically performed to add functionality, such as durability, to a base formed from resin, metal, glass, ceramics, or the like. Metal plating is performed on a variety of components for automobiles and home appliances to improve the ornamentality or add various characteristics such as corrosion resistance, heat resistance, and chemical resistance.

For example, to improve the design properties of a vehicle, an ornamental plated product may be coupled to the vehicle. Such an ornamental plated product includes, for example, a Cu plating layer, an Ni plating layer, and a Cr plating layer that are sequentially stacked on a base formed from a synthetic resin such as acrylonitrile butadiene styrene (ABS) resin. The Cu plating layer is ductile so that it can follow deformation of the ABS resin base. The Ni plating layer improves the corrosion resistance of the ornamental plated product by providing sacrificial corrosion protection. The Cr plating layer adds luster to the outer appearance of the ornamental plated product.

Patent document 1 discloses fixing a hood molding to a mount, which may be a vehicle body, with a metal bolt and nut or a coupling member such as a metal clip. As shown in FIG. 3, a rear surface of a hood molding 100 includes a bolt retainer 130 provided with a first side wall 110 and a second side wall 120 that define a cavity for accommodating a head 310 of a bolt 300. A front edge of a hood outer panel 200 includes a coupling hole 210. The bolt 300 has a shank 320 formed integrally with a washer 330. The first side wall 110 and the second side wall 120 of the bolt retainer 130 hold the bolt 300 between the head 310 and the washer 330. When the bolt 300 is held by the bolt retainer 130, the shank 320 of the bolt 300 is inserted through the coupling hole 210 of the hood outer panel 200. Then, a nut 400 is fastened to the shank 320 to fix the hood molding 100 to the front edge of the hood outer panel 200.

Patent document 2 discloses fixing a radiator grille to a vehicle hood with a bolt and a nut.

Patent document 3 discloses a method for manufacturing a radiator grille of a vehicle. To add a dark metallic luster to the radiator grille, the method includes forming an underlayer plating layer on a synthetic resin base made of an ABS resin to add conductivity, forming a chrome plating layer through electroplating process, and forming a smoke clear layer by spraying a mixture of a transparent resin and pigment onto the chrome plating layer.

Patent document 4 discloses an exterior product for a vehicle in which resin layers are stacked on a metal plating layer that covers a synthetic resin base. The resin layers include a chipping resistance film formed by applying an olefin primer, a polyol high-elasticity film, and a smoke-colored film including a pigment.

Patent documents 5 and 6 each disclose an ornamental plated product including an ornamental portion, to which plating having a metallic luster color is applied, and a cylindrical coupling portion, which is coupled to a through hole formed in a mount.

### PRIOR ART DOCUMENTS

### Patent Documents

Patent Document 1: Japanese Laid-Open Patent Publication No. 2006-175916
Patent Document 2: Japanese Laid-Open Patent Publication No. 6-219224
Patent Document 3: Japanese Laid-Open Patent Publication No. 2002-240189
Patent Document 4: Japanese Laid-Open Utility Model Publication No. 04-061674
Patent Document 5: Japanese Laid-Open Patent Publication No. 2008-308141
Patent Document 6: Japanese Laid-Open Patent Publication No. 2011-105059

### SUMMARY OF THE INVENTION

### Problems to be Solved by the Invention

The inventors of the present invention have noticed several potential problems of the prior art. More specifically, when an ornamental plated product, such as a hood molding or a radiator grille, includes a plating layer on an outermost layer and is fixed to a vehicle by a metal coupling component, contact and/or friction between the ornamental plated product and the coupling member may form a partial battery that causes corrosion at the portion of contact between the ornamental plated product and the coupling member. For example, as shown by the double-headed arrows in FIG. 3, the difference in the oxidation-reduction potential between the Cr plating layer exposed from the surface of the hood molding 100 and the metal (e.g., iron) of the bolt 300 and the nut 400 may result in the formation of a partial battery that advances surface corrosion.

When vibration produced by the traveling vehicle is transmitted to the portion of contact between the ornamental plated product and the coupling member, friction between the metals at the contact portion may generate a jarring noise.

The radiator grille manufacturing method of patent document 3 stacks a metal plating layer entirely on a portion that is immersed in a metal plating solution during electroplating process and forms a synthetic resin layer entirely on a portion that is sprayed. As a result, the boundary between the ornamental portion and the non-ornamental portion is not clear, and there is room for improvement in the ornamentality of the ornamental plated product. Further, the formation of the ornamental plating where there is no need for ornamentality increases material costs.

When masking portions other than design surfaces that need to be ornamental before performing electroplating process, the masking will increase work and lower the workability and the productivity. The masking work increases drastically when a single ornamental plated product includes many portions that do not need to be ornamental, when an ornamental plated product has a complicated shape, or when a portion that needs to be re-masked is recessed.

In the manufacturing methods of patent documents 3 and 4, a resin layer is formed through spraying. Thus, it is difficult to form a uniform resin layer on the entire surface of an ornamental plated product having a ladder structure, a grid structure, or a multiple-recess structure.

In the ornamental plated product of patent document 5, the coupling portion is fitted into the through hole. Then, the distal end of the coupling portion projecting out of the rear surface of the mount undergoes thermal swaging to restrict separation from the through hole. This fixes the coupling portion to the mount. In the ornamental plated product of patent document 6, the distal end of a pin fitted into an insertion hole of the mount is melted and deformed through ultrasonic welding and fixed to the mount. In patent documents 5 and 6, to improve productivity, a plating layer may be formed continuously covering the ornamental portion of the ornamental plated product and the coupling portion on the rear surface of the ornamental plated product. However, a hard plating layer, for example, a Cr plating layer, formed on the coupling portion may impede the melting and deformation of the distal end of the coupling portion. Further, the productivity will decrease when masking the coupling portion with a cap or a tape before a plating process. When omitting the hard plating layer or reducing the thickness of the hard plating layer, the desired outer appearance characteristics and the desired functionality may not be added to the ornamental portion.

It is an object of the present invention to provide an ornamental plated product that solves one or more of potential problems of the prior art.

For example, it is an object of several aspects of the present invention to provide an ornamental plated product and a coupling structure that do not decrease the corrosion resistance of the portion of the ornamental plated product contacting the coupling portion and reduce noise generated at the contact portion.

It is an object of several other aspects of the present invention to easily provide an ornamental plated product including an ornamental plating layer that selectively covers only a desired portion.

It is an object of further aspects of the present invention to provide an ornamental plated product including a plating layer having a ladder structure, a grid structure, or a multiple-recess structure with a plating layer that adds the desired outer appearance characteristics and the desired functionality to the ornamental plating layer.

It is an object of other aspects of the present invention to provide an ornamental plated product that improves the productivity and includes a coupling portion and an ornamental portion that adds the desired outer appearance characteristics and the desired functionality to the ornamental plated product.

### Means for Solving the Problems

A first aspect of the present invention is an ornamental plated product for use with a metal coupling member. The ornamental plated product is provided with a base including a contact portion shaped to be engageable with the metal coupling member, at least one plating layer that covers the base and includes a metal that differs from a metal included in the metal coupling member, and a synthetic resin layer that covers the plating layer where at least the contact portion is located.

This structure prevents or reduces the formation of a partial battery resulting from the plating layer because the plating layer is covered by a synthetic resin layer at the contact portion. This structure is particularly preferred when fixing an ornamental plated product to a mount with a metal coupling member including a metal that differs from the metal of the plating layer.

Further, the metal coupling portion does not contact the outermost plating layer because of the synthetic resin layer. This reduces the generation of a jarring noise caused by friction between metals.

In some implementations, the base includes a design surface that differs from the contact portion, the plating layer covers the design surface and the contact portion of the base, and the synthetic resin layer is a transparent or translucent synthetic resin layer that integrally covers the plating layer on the design surface and the contact portion of the base.

In this structure, the synthetic resin layer is a transparent or translucent synthetic resin layer. This maintains the design properties of the ornamental plated product in a preferred manner without adversely affecting the outer appearance characteristics such as the luster of the outer appearance of the plating layer that covers the design surface. Further, the synthetic resin layer integrally covers the plating layer on the design surface and the contact portion. Thus, the formation of the synthetic resin layer is not complicated.

In some implementations, the synthetic resin layer is an electrodeposition paint composition or a hardened electrodeposition paint composition. This structure facilitates the formation of the synthetic resin layer on the entire surface of the ornamental plated product.

In some implementations, the plating layer includes an outermost plating layer that is an Sn or Sn alloy layer. In this structure, the Sn or Sn alloy plating layer adds a superior color tine and luster to the outer appearance of the ornamental plated product and also adds superior functionality such as surface smoothness, rigidity, and corrosion resistance.

Some implementations provide a coupling structure including the ornamental plated product according to the first aspect and a metal coupling member configured to engage the contact portion of the ornamental plated product and fix the ornamental plated product to a mount. This structure prevents or reduces the formation of a partial battery and the generation of noise resulting from contact or friction between the ornamental plated product and the metal coupling member.

A second aspect of the present invention is an ornamental plated product including a base, a plating layer that covers the base, and a synthetic resin layer that covers the plating layer. The base is an integrated two-color molded product of a first synthetic resin base and a second synthetic resin base, the plating layer includes a metal plating layer that entirely covers only a selected surface of the first synthetic resin base, and the synthetic resin layer includes an electrodeposition paint composition or a hardened electrodeposition paint composition.

In this structure, the difference in the properties of the first and second synthetic resin base of the two-color molded product forms a metal plating layer on the first synthetic resin base and forms the synthetic resin layer through electrodeposition coating on only the metal plating layer that is conductive. This easily obtains the ornamental plated product on which an ornamental film is formed including the metal plating layer and the synthetic resin layer on the first synthetic resin base. Further, the boundary becomes clear between the portion where the ornamental film is formed and the portion where the ornamental film is not formed. Thus, the ornamental plated product has superior outer characteristics.

In some implementations, the ornamental plated product further includes a boundary between the first synthetic resin base and the second synthetic resin base. In this structure, the boundary becomes further clear between the portion where the ornamental film is formed and the portion where the ornamental film is not formed. For example, when forming the boundary as a step between the first synthetic resin base and the second synthetic resin base, the portion where the ornamental film is formed and the portion where the ornamental film is not formed are adjacent to each other at the step. Thus, the boundary becomes further clear at the portion where the ornamental film is formed and the portion where the ornamental film is not formed.

A third aspect of the present invention provides a method for manufacturing an ornamental plated product. The method includes an electroless plating step of forming an electroless plating layer that entirely covers only a selected surface of a first synthetic resin base in a two-color molded synthetic resin base, an electroplating step of forming a metal plating layer on the electroless plating layer, and an electrodeposition painting step that forms a synthetic resin layer on the metal plating layer.

In this structure, the properties of the first synthetic resin base in the two-color molded product selectively forms the electroless plating layer on only the first synthetic resin base. This forms metal plating layer selectively on only the electroless plating layer. Further, the synthetic resin layer is formed by performing the electrodeposition painting to selectively form the synthetic resin layer on only the metal plating layer. Such series of steps facilitates selective formation of the ornamental film on only the first synthetic resin base.

In some implementations, the electrodeposition painting step irradiates ultraviolet rays and hardens a resin film to form the synthetic resin layer. This structure hardens the synthetic resin layer at a relatively low temperature and thus reduces the thermal effect on the synthetic resin base. Further, there is no need to raise the temperature to a high temperature like when performing thermosetting. Thus, the synthetic resin layer can be efficiently formed.

In some implementations, the electroplating step forms the metal plating layer on a plurality of two-color molded products at the same time; the electrodeposition painting step forms the synthetic resin layer on the plurality of two-color molded products, on which the metal plating layer has been formed, at the same time; and the plurality of two-color molded products are arranged next to one another so that a front surface of the first synthetic resin base of each of the plurality of two-color molded products is opposed to an electrode in the electroplating step and the electrodeposition painting step.

In this structure, the ornamental plated produces are easily provided with uniform quality. For example, the front surfaces of the first synthetic resin bases in the two-colored molded products are covered with metal plating layers and/or synthetic resin layers having uniform thickness.

A fourth aspect of the present invention is an ornamental plated product including a base and a plating layer that covers the base. The base has a ladder structure, a grid structure, or a multiple-recess structure. The plating layer includes a metal plating layer that covers an entire surface of the base and has a thickness of 0.03 μm or greater, and a transparent or translucent synthetic resin layer that covers the metal plating layer and includes an electrodeposition paint composition or a hardened electrodeposition paint composition.

In some implementations, the synthetic resin layer has a thickness of 5 μm or greater. This structure further improves functionality such as durability.

In some implementations, the metal plating layer includes at least one selected from Ni, Cu, Cr, Sn, and Sn alloy. This structure further improves ornamentality by adding a metallic luster color to the surface of the ornamental plated product.

In some implementations, the base metal plating layer has a thickness profile including a first thickness at a first portion of the base and a second thickness, which differs from the first thickness, at a second portion of the base. This structure forms the synthetic resin layer with the desired thickness through electrodeposition painting on an ornamental plated product that has a ladder structure, a grid structure, or a multiple-recess structure and provides the synthetic resin layer with sufficient outer appearance characteristics and functionality.

In some implementations, the ornamental plated product is an ornamental product for a vehicle. In a vehicle ornamental product having a complicated structure from the viewpoint of design or functionality such as a front grille, the plating layer can be formed on the entire ornamental product to add sufficient outer appearance characteristics and functionality.

A fifth aspect of the present invention is an ornamental plated product including a base and a plating layer that covers the base to provide the base with an ornamental portion. The base includes a coupling portion that differs from the ornamental portion. The coupling portion is configured to be coupled to a mount, and the coupling portion includes a distal end formed from a fusible and deformable resin for engagement in a fixed manner with the mount. The plating layer includes a Cu plating layer that covers the base, an Sn or Sn alloy layer that directly contacts and covers the Cu plating layer, and a synthetic resin layer that covers the Sn or Sn alloy plating layer. The plating layer that provides the ornamental portion continuously extends from at least a surface of the distal end of the coupling portion.

In this structure, a fusing portion is included in the plating layer formed by sequentially stacking the Cu plating layer, the Sn or Sn alloy plating layer, and the synthetic resin layer. This enables fusing and deformation of the fusing portion when coupling the ornamental plated product. Thus, masking processes of the fusing portion can be omitted during a plating process, and the productivity can be improved.

In some implementations, the synthetic resin layer includes an electrodeposition paint composition or a hardened electrodeposition paint composition. In this structure, a synthetic resin layer that continuously covers the surface of the ornamental portion to the surface of the fusing portion can be formed through electrodeposition painting. This improves the productivity.

In some implementations, the synthetic resin layer is formed from a resin having a glass transition temperature of 25° C. or greater and a fusing-deforming temperature that is less than or equal to that of the distal end.

A fifth aspect of the present invention is a method for coupling the ornamental plated product of the fourth aspect to a mount. The method includes the step of fixing the ornamental plated product to the mount by fusing and deforming the distal end of the coupling portion, which is covered by the plating layer, in a state engaged with the mount. Thus, masking processes of the fusing portion can be omitted during a plating process, and the productivity can be improved.

### Effect of the Invention

Several aspects of the present invention provide an ornamental plated product that limits decreases in the corrosion resistance at the contact portion and limits the generation of noise at the contact portion. Several other aspects of the present invention easily provide an ornamental plated product including an ornamental film that selectively covers only the desired portion. Further aspects of the present invention provide an ornamental plated product including a plating layer having a ladder structure, a grid structure, or a multiple-recess structure with a plating layer that adds the desired outer appearance characteristics and the desired functionality to the ornamental plating layer. Other aspects of the present invention provide an ornamental plated product that improves the productivity and adds the desired outer appearance characteristics and the desired functionality to the ornamental portion.

Other aspects and advantages of the present invention will become apparent from the following description, taken in conjunction with the accompanying drawings, illustrating by way of example the principles of the invention.

### BRIEF DESCRIPTION OF THE DRAWINGS

FIG. 1A is a schematic cross-sectional view of an ornamental plated product according to a first embodiment of the present invention coupled to a mount by a coupling member.

FIG. 1B is a partially enlarged view of FIG. 1A.

FIG. 2 is a partial perspective view of the ornamental plated product shown in FIG. 1A.

FIG. 3 is a cross-sectional view of a prior art ornamental plated product.

FIG. 4A is a perspective view of a second embodiment of an ornamental plated product with a cap, and FIG. 4B is a perspective view of the ornamental plated product without the cap.

FIG. 5A is a cross-sectional view taken along line V-V in FIG. 4A, and FIG. 5B is a cross-sectional view illustrating an ornamental film.

FIG. 6 is a schematic diagram illustrating an electroplating step.

FIG. 7 is a perspective view of a third embodiment of an ornamental plated product.

FIG. 8 is a cross-sectional view taken along line VIII-VIII in FIG. 7.

FIG. 9 is a cross-sectional view illustrating a thickness profile of the plating layer in the third embodiment.

FIG. 10 is a partial cross-sectional view of a fourth embodiment of an ornamental plated product fixed to a mount.

FIG. 11 is a cross-sectional view of a plating layer in a fourth embodiment of an ornamental plated product.

### EMBODIMENTS OF THE INVENTION

An ornamental plated product according to a first embodiment of the present invention will now be described. The ornamental plated product of the first embodiment is a radial grille cover coupled to a mount of a vehicle body with a bolt and a nut. The mount, which may be a vehicle body, may be referred to as a first metal member that is separate from the ornamental plated product. The bolt and the nut may each be referred to as a second metal member that is separate from the coupling member and the ornamental plated product.

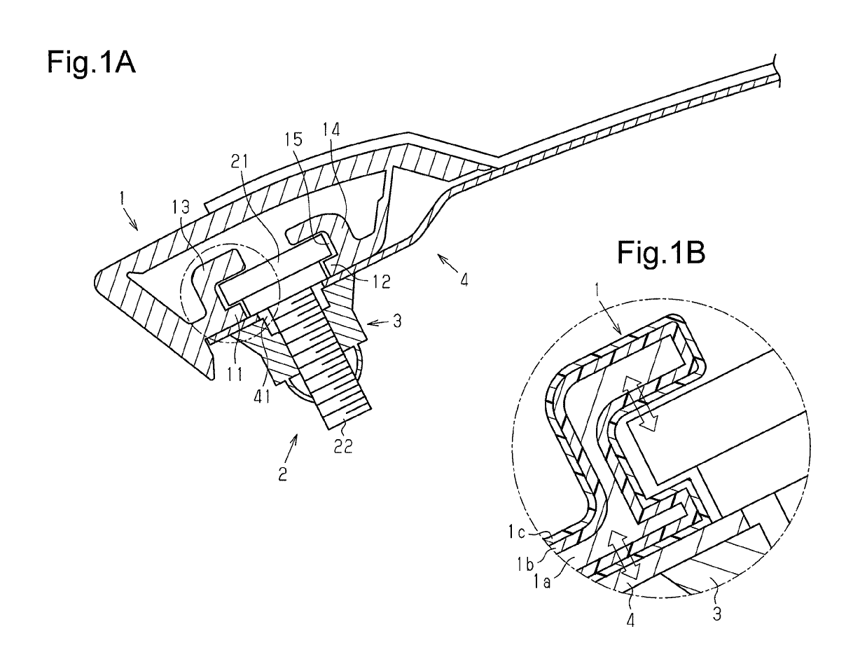

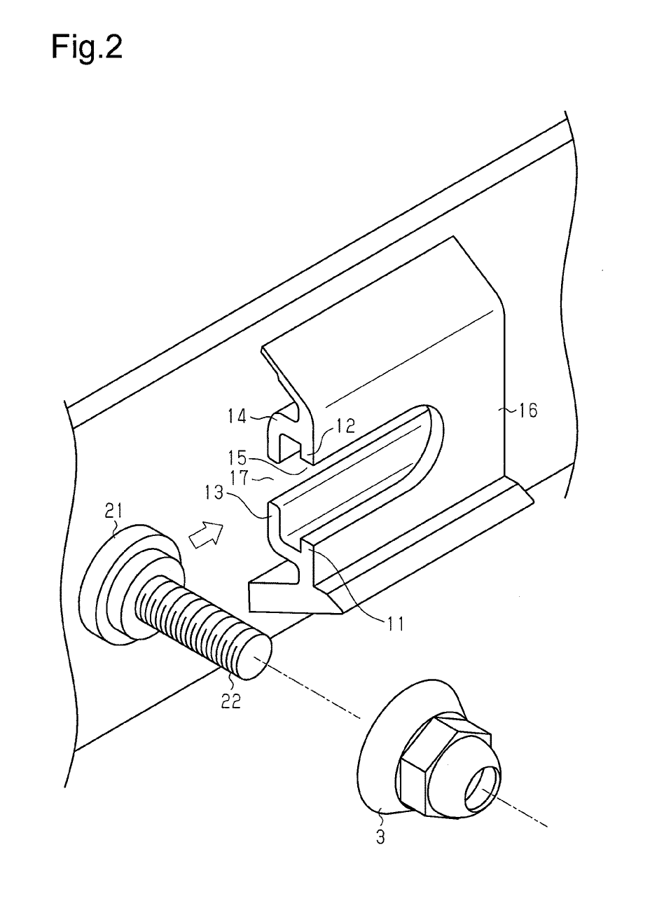

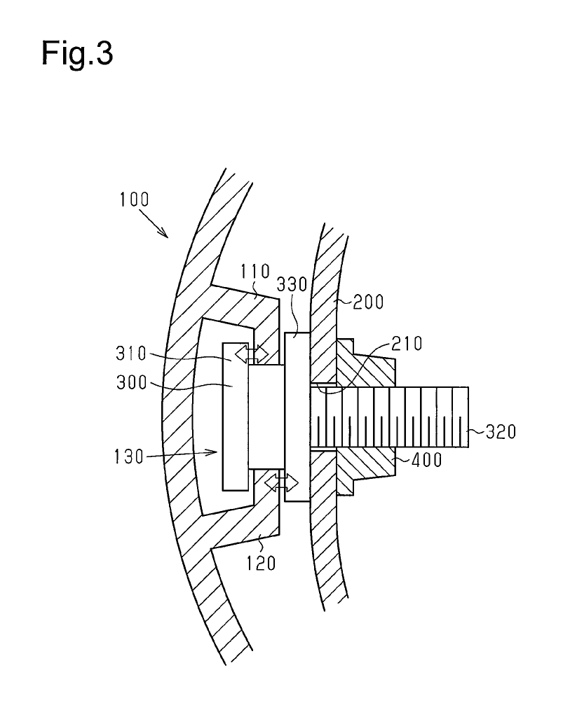

As shown in FIG. 1A, support walls 11 and 12, which support a head 21 of a bolt 2 from below, and side walls 13 and 14, which project from the support walls 11 and 12 and support the head of the bolt 2 from above, are formed on a rear surface of a radiator grille cover 1. The support walls 11 and 12 and the side walls 13 and 14 configure a bolt retainer 15 including a void or a groove capable of accommodating the head 21 of the bolt 2. A vehicle body 4 includes an insertion hole 41 into which a shank 22 of the bolt can be inserted.

To couple the radiator grille cover 1 to the vehicle body 4, the shank 22 of the bolt 2 is inserted into the insertion hole 41 of the vehicle body 4, with the head 21 of the bolt 2 fitted to the bolt retainer 15 of the radiator grille cover 1. A nut 3 is fastened to the shank 22 of the bolt 2, which projects out of the insertion hole 41 of the vehicle body 4, to couple the radiator grille cover 1 to the vehicle body 4.

The material of the radiator grille cover 1 of the first embodiment will now be described.

In the radiator grille cover 1 of the first embodiment, one or more plating layers are formed on a base made of resin, metal, glass, ceramic, or the like. A synthetic resin layer, which serves as a protection layer, is formed on the outermost one of the plating layers. The synthetic resin layer may be the outermost layer of the radiator grille cover 1.

The material of the base is not limited, and a known material may be selected in accordance with the application. A resin base may be selected taking into consideration rigidity, processing easiness, heat resistance, plating easiness, and the like. Examples of a resin include ABS resin, polycarbonate (PC) resin, PC/ABS alloy (PC/ABS blend resin), polypropylene (PP) resin, polyacrylic resin (polymethacrylic resin), polymethylmethacrylate (PMMA) resin, modified polyphenylene ether (PPE) resin, polyamide resin, polyacetal resin, and the like. One of these bases may be selected. Alternatively, more than one of these bases may be selected. Further, the resin base may be molded through a known molding process, for example, injection molding, extrusion molding, blow molding, compression molding, or the like.

Examples of a metal base include stainless steel, Al, an Al alloy, Ti, a Ti alloy, and the like.

The configuration of the plating layers on the base is not particularly limited and may be formed by selecting a known plating process in accordance with the application and the function of the ornamental plated product. One example of a plating layer of the radiator grille cover 1 of the first embodiment will now be described in which a Cu plating layer is plated on the surface of a base, and an Sn plating layer or an Sn alloy plating layer is stacked on the Cu plating layer.

In the radiator grille cover 1 of the first embodiment, a Cu plating layer is plated on the surface of the base. The Cu plating layer may be formed through a Cu electroless plating process or a Cu electroplating process. The process for forming the Cu plating may be selected in accordance with the characteristics of the plating layer. When performing Cu electroplating process, conductivity is added to the surface of the base. Thus, electroless plating process needs to be performed before performing Cu electroplating process. In addition to Cu electroless plating process, the electroless plating process may be an Ni electroless plating process.

A known process may be employed as the Cu electroless plating process. One example of a Cu electroless plating process is formaldehyde bathing using formaldehyde as a reductant. Further, bathing may be performed using a reductant of potassium tetrahydroborate, DMAB, a boron hydride such as sodium borohydride, glyoxylate, hypophosphite, phosphinate, cobalt(II) salt, hydrazine, or the like. For example, when performing formaldehyde bathing, in addition to using formaldehyde as a reductant, the plating bath may include copper sulfate as a copper salt, Rochelle salt and ethylenediaminetetraacetic acid (EDTA) as a complexing agent, a pH adjuster, a stabilizer, an accelerator, a film modifier, a surfactant, and the like.

A known process may be employed as the Ni electroless plating process. For example, when using ABS resin as the base, the base is immersed in a bath containing a surfactant. After degreasing the surface of the base, the base is immersed in a chromic acid/sulfuric acid solution and the base surface undergoes etching. Subsequently, a catalyst such as a Pd/Sn mixture colloidal catalyst is added to the base surface and activated before performing the No electroless plating process. When performing Ni electroless plating process, the plating bath may include a reductant of phosphinate, tetrahydrocannabinol borate, dimethyl amine borane (DMAB), hydrazine, or the like, a nickel salt of nickel sulfate, nickel chloride, or the like, a complexing agent, an accelerator, a stabilizer, a pH adjuster, a surfactant, and the like.

Further, a known process may be employed as the Cu electroplating process. The plating bath may be, for example, any of a copper cyanide bath containing cuprous cyanide and sodium cyanide, a copper pyrophosphate bath containing copper pyrophosphate and potassium pyrophosphate, and a copper sulfate bath containing copper sulfate. Each bath may contain known additives, for example, a leveling agent, an accelerator, an inhibitor, and the like. The additives may be added by adjusting the blending amount and ratio in accordance with the condition of the base surface, for example, the surface roughness and the warping.

The thickness of the Cu plating layer on the base may be set taking into consideration ductility, surface accuracy, surface hardness, productivity, and the like. The lower limit of the thickness of the Cu plating layer on the base is preferably 5 μm or greater, more preferably 6 μm or greater, and further preferably, 7 μm or greater. When the thickness is 5 μm or greater, the ductility, the surface accuracy, the surface hardness, or the like may be further improved. The upper limit of the thickness of the Cu plating layer is preferably 30 μm or less, more preferably 25 μm or less, and further preferably, 20 μm or less. When the thickness is 30 μm or less, the productivity can be improved, for example, the manufacturing cost can be further reduced.

In the radiator grille cover 1 of the first embodiment, an Sn plating layer or an Sn alloy plating layer is directly stacked on the Cu plating layer. The Cn or Sn alloy plating layer adds metallic luster to the outer appearance of the radiator grille cover 1 as if a Cr plating process has been performed. Examples of the Sn alloy used to form the Sn alloy plating layer include an Sn—Co alloy, an Sn—Ni alloy, an Sn—Pb alloy, an Sn—Ni—Cu alloy, an Sn—Cu—Zn alloy, an Sn—Fe alloy, an Sn—Fe—Zn alloy, and the like. One of these Sn alloys may be selected and used. Alternatively, more than one of these Sn alloys may be used in combination.

A known process may be employed as the Sn plating process or the Sn alloy plating process. The plating bath may be any one of an acid bath, an alkali bath, and a neutral bath. An acid bath may be any one of a sulfuric acid bath, a borofluoride bath, and an organic sulfonic acid bath. For example, when employing an organic sulfonic acid bath, stannous sulphate, cresol sulfonic acid, a formalin compound (formaldehyde), an amine-aldehyde brightening agent, a surfactant, a pH adjustor, and the like may be dissolved in a methanesulfonic acid bath. An electroplating process is performed on the methanesulfonic acid bath under the conditions in which the processing temperature is 10° C. to 20° C., the cathode current density is 0.3 to 1.5 A/dm², and the anode current density is 1.0 to 3.0 A/dm².

The thickness of the Sn plating layer or the Sn alloy plating layer stacked on the Cu plating layer may be set taking into consideration the outer appearance characteristics of the radiator grille cover 1 such as the color tone of the design surface, the surface accuracy, the surface hardness, the productivity, and the type of the Sn alloy. When using, for example, an Sn or Sn—Ni alloy, the lower limit of the plating layer thickness is preferably 1 μm or greater, more preferably 3 μm or greater, and further preferably 5 μm or greater. When the thickness is 1 μm or greater, the preferred outer appearance characteristics can be obtained. The upper limit of the plating layer thickness is preferably 30 μm or less, more preferably 25 μm or less, and further preferably 20 μm or less. When the thickness is 30 μm or less, the productivity can be improved, for example, the manufacturing cost can be further reduced.

When using, for example, an Sn—Co alloy plating, the lower limit of the plating layer thickness is preferably 0.1 μm or greater, more preferably 0.2 μm or greater, and further preferably 0.3 μm or greater. When the thickness is 0.1 μm or greater, the preferred outer appearance characteristics can be obtained for the radiator grille cover 1. The upper limit of the plating layer thickness is preferably 1 μm or less, more preferably 0.9 μm or less, and further preferably 0.8 μm or less. When the thickness is 1 μm or less, the productivity can be improved, for example, the manufacturing cost can be further reduced.

To add luster to the outer appearance of the base with an Sn plating layer or an Sn alloy plating layer, the Sn plating bath or Sn alloy plating bath may contain a brightening agent. The brightening agent may be known. Examples of a brightening agent include an aldehyde compound brightening agent and an unsaturated carboxylic acid compound brightening agent.

One of these brightening agents may be selected and used. Alternatively, more than one of these brightening agents may be used in combination. The added amount of the brightening agent may be set by the type of the added brightening agent. The total concentration of the brightening agent in the Sn plating bath or the Sn alloy bath is preferably 0.01 to 1 g/L. When the concentration of the brightening agent is 0.01 g/L or greater, the dispersion and adhesion of Sn to the Cu plating surface becomes satisfactory, and suitable luster may be added to the outer appearance of the radiator grille cover 1.

An organic synthetic resin layer is formed as a protection layer on the surface of the Sn plating layer or Sn alloy plating layer of the radiator grille cover 1. The synthetic resin layer is formed on the entire radiator grille cover 1 including the coupling portions (support walls 11 and 12 and the side walls 13 and 14) used when coupling the radiator grille cover 1 to the vehicle body 4.

When coupling the radiator grille cover 1 to the vehicle body 4 with the bolt 2 and the nut 3, the synthetic resin layer prevents contact of the Sn plating layer or the Sn alloy plating layer at the plating layer surface of the radiator grille cover 1 with the metal of the bolt 2 and the nut 3. Further, direct contact is prevented between the metal of the vehicle body 4 and the Sn plating layer or the Sn alloy plating layer at the plating layer surface of the radiator grille cover 1.

A known protection layer used to protect the plating layer surface may be used as the synthetic resin layer. Taking into consideration the visibility of the Sn plating layer or the Sn alloy plating layer on the design surface of the radiator grille cover 1, a transparent or translucent synthetic resin is used. A translucent synthetic resin layer need only be transparent enough to allow the design of the Sn plating layer or the Sn alloy plating layer to be seen through the synthetic resin layer when viewed from the upper side. The transparent or translucent synthetic resin layer adds corrosion resistance to the Sn plating layer or the Sn alloy plating layer and achieves a sufficient ornamental effect by allowing the design surface to be seen therethrough. Further, the synthetic resin layer may contain a coloring agent such as a pigment or a dye to add a color and further improve the design properties and ornamentality of the radiator grille cover 1.

Examples of the resin used to form the organic synthetic resin layer include an acrylic resin (methacrylic resin), polycarbonate resin, urethane resin, and melamine resin. Among these resins, ultraviolet curing polyfunctional acrylic resin is preferred since it has superior corrosion resistance, chemical resistance, abrasion resistance, ductility, transparency, and handling characteristics. One of these resins may be selected and used for the transparent or translucent synthetic resin. Alternatively, more than one of these resins may be used in combination to obtain the transparent or translucent synthetic resin.

The process for applying a coating agent used to form the synthetic resin layer may be selected in accordance with the type of each coating agent. Specific examples of such a process include electrodeposition painting, spin coating, coating, spraying, flowing, immersing (dipping), and electrostatic painting. When using a thermosetting resin, thermosetting painting may be employed in which a coating agent is applied and then heated and hardened. When using an ultraviolet curing resin, ultraviolet curing painting may be employed in which a coating agent is applied and then irradiated with ultraviolet rays and hardened.

Among these applying processes, electrodeposition painting is preferred when taking into consideration the superior corrosion resistance and outer appearance characteristics. Electrodeposition painting is a painting process that applies static electricity of different electrodes to the paint and the painted subject, places the painted subject in a water-based paint, and cause electrodeposition on the painted subject through electrophoresis to form an electrodeposition layer. The paint is a conductive aqueous solution or an emulsion. There are two types of paints, anion electrodeposition paint and cation electrodeposition paint. When using a thermosetting paint for the electrodeposition painting, heating and hardening may be performed after electrodeposition. When using an ultraviolet curing paint, ultraviolet ray irradiation may be performed to cause hardening after electrodeposition. For example, as described in Japanese Laid-Open Patent Publication No. 5-263026 and Japanese Laid-Open Patent Publication No. 2010-47692, the composition for an ultraviolet curing paint may be an acrylic resin formed by hardening methacrylate with ultraviolet rays to cause radical polymerization.

When performing electrodeposition painting, the radiator grille cover 1 is placed in a vessel containing paint, and electrophoresis is performed with the radiator grille cover 1 entirely immersed in the paint. This forms an integrated synthetic resin layer on the design surface of the radiator grille cover 1 and the rear surface of the radiator grille cover 1 including the portion coupled to the vehicle body 4. The integrated synthetic resin layer may be a synthetic resin layer that is seamless. Further, the synthetic resin layer may be an electrodeposition paint composition or the cured electrodeposition paint composition.

The thickness of the synthetic resin layer on the Sn plating layer or the Sn alloy plating layer is not particularly limited as long as corrosion resistance is added to the surface of the radiator grille cover 1 by functioning to prevent contact of the plating layer with the coupling portion, and as long as the design of the Sn plating layer or the Sn alloy plating layer can be seen through the synthetic resin layer when viewed from above. The lower limit of the thickness of the synthetic resin layer is preferably 5 μm or greater, more preferably 6 μm or greater, and further preferably 7 μm or greater. When the thickness is 5 μm or greater, the function for protecting the underlayer is further improved. The upper limit of the synthetic resin layer is preferably 30 μm or less, more preferably 25 μm or less, and further preferably 20 μm or less. When the thickness is 30 μm or less, the productivity can be improved, for example, the manufacturing cost can be further reduced, and the visibility can be improved.

As shown in FIG. 1B, these series of processes forms the plating layer 1b, which includes a Cu plating layer and an Sn plating layer or an Sn alloy plating layer, and a synthetic resin layer 1c on a ABS resin base 1a in the radiator grille cover 1 of the first embodiment.

The bolt 2 and the nut 3 of the first embodiment will now be described.

The bolt 2 and the nut 3 may be those that are known in the art. The material of the bolt 2 and the nut 3 may be steel, martensite stainless steel, ferrite stainless steel, austenite stainless steel, brass, titanium, a titanium alloy, aluminum, or a resin. The resin has a plating layer formed on its surface. The type of the metal forming the plating layer is not particularly limited. Plating layer may also be formed on the surfaces of the bolt 2 and the nut 3 formed from steel, martensite stainless steel, ferrite stainless steel, austenite stainless steel, brass, titanium, a titanium alloy, or aluminum.

In the first embodiment, the bolt 2 and the nut 3 that are made of steel and are immersed in an electrolyte solution including Zn metal salt and Ni metal salt to undergo an electrolytic plating process that forms a Zn—Ni plating layer, which further undergoes a chromate treatment that is free from hexavalent chromium.

The shape and size of the bolt 2 and the nut 3 are not particularly limited. The shape and size may be set in accordance with the shape and size of the bolt retainer 15 formed on the radiator grille cover 1 and the shape and size of the insertion hole 41 formed in the vehicle body 4.

The coupling structure that couples the radiator grille cover 1 to the vehicle body 4 with the bolt 2 and the nut 3 will now be described.

As shown in FIG. 1A, the rear surface of the radiator grille cover 1 includes the bolt retainer 15, which includes the void or groove surrounded by the support walls 11 and 12 and the side walls 13 and 14. As shown in FIG. 2, the bolt retainer 15 includes an opening 17 (inlet), a stopper wall 16, and a slot extending from the opening 17 to the stopper wall 16.

As shown by the arrow in FIG. 2, the head 21 of the bolt 2 is first inserted into the bolt retainer 15 from the opening 17, and the shank 22 of the bolt 2 is projected out of the support walls 11 and 12. Separation of the bolt 2 from the bolt retainer 15 is restricted with the head 21 abut against the stopper wall 16. Then, as shown in FIG. 1A, the shank 22 projecting from the gap between the support walls 11 and 12 is inserted into the insertion hole 41, which is formed in the vehicle body 4. The nut 3 is fastened and tightened to the shank 22, which projects out of the insertion hole 41. This securely fixes the radiator grille cover 1 to the vehicle body 4.

As shown in FIG. 1B, the radiator grille cover 1 includes the ABS resin base 1a, the plating layer 1b, and the synthetic resin layer 1c. When the radiator grille cover 1 is fixed to the vehicle body 4, the support walls 11 and 12 and the side walls 13 and 14 of the radiator grille cover 1 are in contact with the head 21 of the bolt 2 and the vehicle body 4. However, the synthetic resin layer 1c is formed on the entire surface of the plating layer 1b, which is formed on the radiator grille cover 1. Thus, the plating layer 1b does not directly contact the bolt 2 and the vehicle body 4.

The operation of the ornamental plated product and the coupling structure will now be described.

The plating layer 1b of the radiator grille cover 1 in the first embodiment includes the Sn plating layer or the Sn alloy plating layer as the outermost plating layer. The synthetic resin layer 1c is formed on the Sn plating layer or the Sn alloy plating layer. A Sn—Ni plating layer is plated on the bolt 2 and the nut 3. Accordingly, when the radiator grille cover 1 is coupled to the vehicle body 4 with the bolt 2 and the nut 3, the synthetic resin layer 1c of the radiator grille cover 1 is located between the Sn plating layer or Sn alloy plating layer of the radiator grille cover 1 and the Zn—Ni plating layer of the bolt 2 and the nut 3 and acts to restrict contact of the Sn plating layer or Sn alloy plating layer with the Zn—Ni plating layer.

When the synthetic resin layer 1c is not formed on the radiator grille cover 1, the Sn plating layer or the Sn alloy plating layer comes into contact with the Zn—Ni plating layer, and the difference in the oxidation-reduction potential between the metals causes an oxidation reduction reaction that forms a partial battery. However, in the first embodiment, the synthetic resin layer 1c, which is formed on the radiator grille cover 1, acts to restrict the formation of a partial battery.

The Sn plating layer or the Sn alloy plating layer, which is the outermost plating layer of the radiator grille cover 1, does not contact the Zn—Ni plating layer of the bolt 2 and the nut 3 because of the existence of the synthetic resin layer 1c. This reduces the generation of jarring noise that occurs when friction occurs between metals.

The transparent or translucent synthetic resin layer 1c allows the Sn plating layer or the Sn alloy plating layer that is the outermost plating layer to be visible.

The ornamental plated product and the coupling structure of the first embodiment obtain the advantages described below

(1-1) In the first embodiment, the synthetic resin layer 1c is formed on the outermost surface of the radiator grille cover 1, which is coupled to the vehicle body 4, and the synthetic resin layer 1c is located between the bolt 2 and the nut 3, which serve as coupling components. This restricts the formation of a partial battery between the Sn plating layer or Sn alloy plating layer at the outermost layer of the plating layer 1b of the radiator grille cover 1 and the Zn—Ni plating layer of the bolt 2 and the nut 3. Further, the corrosion resistance of each member can be improved.

(1-2) The generation of jarring noise or the like caused by friction between metals is reduced. Thus, noise is less annoying when the vehicle is driven.

(1-3) The synthetic resin layer 1c is transparent or translucent so that the Sn plating layer or Sn alloy plating layer at the outermost layer of the plating layer 1b is visible. Accordingly, the formation of the synthetic resin layer 1c maintains the preferred design property without adversely affecting the luster of the outer appearance of the Sn plating layer or Sn alloy plating layer.

(1-4) The formation of the synthetic resin layer 1c adds corrosion resistance, chemical resistance, abrasion resistance, and the like to the radiator grille cover 1. This functions to protect the surface of the radiator grille cover 1.

The above embodiment may be modified as described below.

In the first embodiment, a coupling structure is described that couples the radiator grille cover 1, which serves as an ornamental plated product, to the vehicle body 4, which serves as a first member, with the bolt 2 and the nut 3, which serve as metal coupling components. However, there is no limit to such members. The coupling structure may be applied for members that contact each other at metal portions. The synthetic resin layer 1c may be formed on at least one of the members so that contact does not occur between the metals of the outermost layers of the members.

The coupling component may be a clip or the like instead of the bolt 2 and the nut 3.

In the first embodiment, the radiator grille cover 1 is placed in a vessel containing paint for electrodeposition painting, and electrophoresis is performed with the radiator grille cover 1 entirely immersed in the paint. However, the electrodeposition painting is not limited in such a manner. The radiator grille cover 1 may be divided into a number of parts that separately undergo electrodeposition painting.

In the first embodiment, the Cu plating layer and the Sn plating layer or Sn alloy plating layer are stacked on the ABS resin base. However, the configuration of the plating layer 1b is not limited in such a manner. After performing electroless plating to add conductivity to the ABS resin base, a Cu plating layer that is ductile, Ni plating layers that provide sacrificial corrosion protection, and a Cr plating layer that serves to provide a design may be sequentially stacked on the ABS resin base. Alternatively, other different stacking layers may be sequentially stacked. The configuration of the plating layer 1b may be selected in accordance with the characteristics of the members. In particular, the effect of the first embodiment becomes more prominent as the difference increases in the corrosion potential between the metal of the plating layer 1b in the outermost surface of a member and the metal of the outermost surfaces of the bolt 2 and the nut 3. The plating layer 1b of the member occupies a wide area as the design surface. Thus, it is preferred that the corrosion potential of the metal of the plating layer 1b at the outermost surface of the member be nobler than the metal of the outermost surfaces of the bolt 2 and the nut 3. When the bolt 2 and the nut 3 need to have high corrosion resistance, the corrosion potential of the metal of the outermost surfaces of the bolt 2 and the nut 3 may be nobler than the metal of the plating layer 1b at the outermost surface of the member.

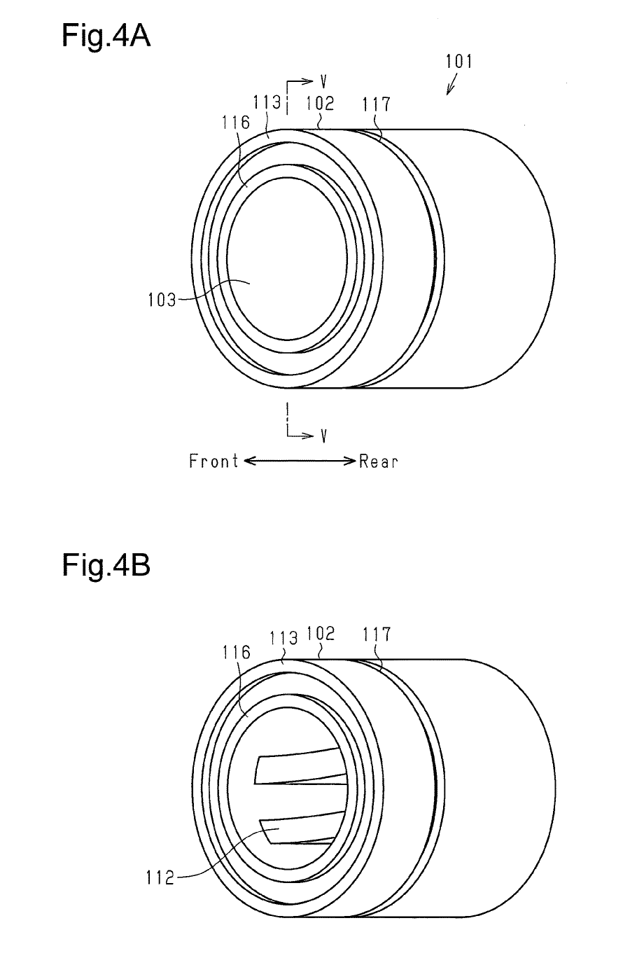

A second embodiment of the present invention will now be described with reference to FIGS. 4 to 6.

FIGS. 4A and 4B show a knob 101 of a car audio used as a vehicle interior component. The knob 101 includes a front surface 113 that is opposed to the user when the user uses the car audio. The knob 100 includes a tube 102 made of a synthetic resin and a cap 103 made of metal. The cap 103 can be fixed to the front surface 103 of the tube 102. In the second embodiment, the tube 102 of the knob 100 corresponds to an ornamental plated product.

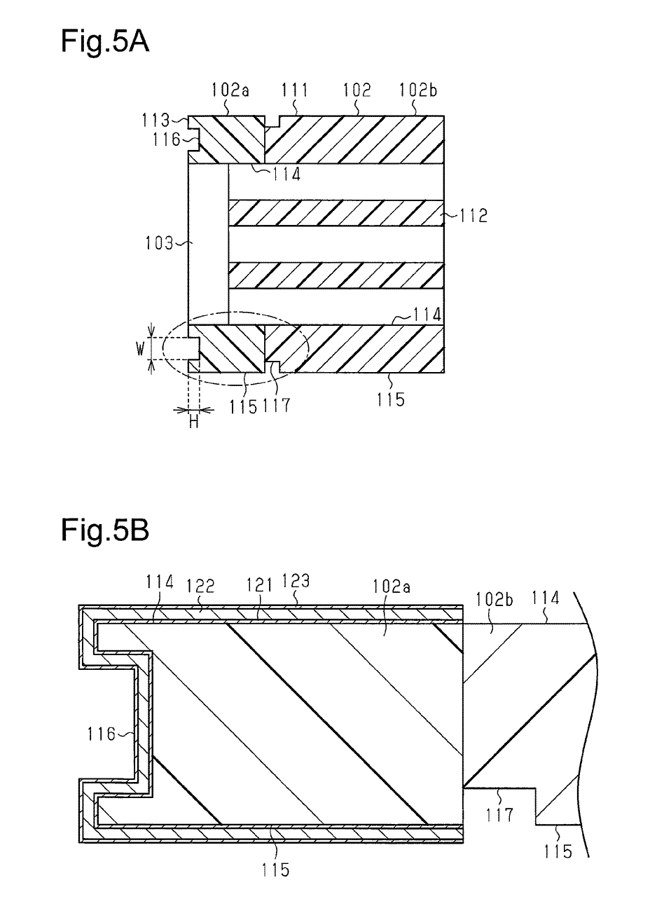

As shown in FIG. 5A, the tube 102 includes an outer tube 111 and two supports 112 extending across the inner circumferential surface of the outer tube 111. The front end surfaces of the supports 112 contact the rear surface of the cap 103 and position the cap 103.

The front surface 113 of the outer tube 111 includes an annular groove 116 having a three-dimensionally corrugated shape and adding ornamentality to the knob 100. The shape of the groove 116 is not particularly limited although it is preferred that the groove width W be greater than the groove depth H. A larger groove width W facilitates the formation of a uniform ornamental film to the inner portion of the groove 116 when performing a metal plating step and electrodeposition painting, which will be described layer. Further, a larger groove width W obtains a satisfactory outer shape for the knob 100.

As shown in FIG. 5A, the tube 102 is a two-color molded product obtained by performing two-color molding with different synthetic resins. In the two-color molded product, a first synthetic resin base 102a is located at the front of the tube 102, and a second synthetic resin base 102b is located at the rear of the tube 102. The supports 112 may be portions of the second synthetic resin base 102b. FIG. 5B is an enlarged cross-sectional view of the portion encompassed by the broken line in FIG. 5A. As shown in FIG. 5B, an ornamental film is plated on only the first synthetic resin base 102a of the outer tube 111 of the tube 102. The ornamental film is plated over the entire first synthetic resin base 102a and includes an electroless plating layer 121, a metal plating layer 122, and a synthetic resin layer 123. An ornamental film is not formed on the second synthetic resin base 102b and the supports 112 of the outer tube 111 of the tube 102.

The first synthetic resin base 102a and the second synthetic resin base 102b, which form the outer tube 111 of the tube 102, may have the same diameter and the same wall thickness. An outer surface 115 of the second synthetic resin base 102b includes a recess or a step at the front end that is adjacent to the first synthetic resin base. This defines a recess groove 117 extending in the circumferential direction along the entire outer surface 115 at a portion where the first synthetic resin base 102a is joined with the second synthetic resin base 102b. An inner surface 114 and an outer surface 115 of the first synthetic resin base 102a are smooth surfaces extending toward the rear and continuously from the annular front surface 113 and does not include an undercut portion.

A method for manufacturing the tube 102 will now be described.

The synthetic resin forming the tube 102 of the knob 100 may be one that is known in the art. In the second embodiment, acrylonitrile butadiene styrene (ABS) resin is used for the first synthetic resin base 102a on which the ornamental film is plated, and polycarbonate (PC) resin is used for the second synthetic resin base 102b on which the ornamental film is not plated. The synthetic resin base 102b may also be formed from PC-ABS resin, polypropylene resin, polyamide resin, polyethylene terephthalate (PET) resin, polymethyl methacrylate (PMMA) resin, polyacetal resin, olefin thermoplastic elastomer (TPO), or the like.

First, an Ni electroless plating process is performed to form an electroless plating layer 121 that adds conductivity to the surface of the first synthetic resin base 102a. The Ni electroless plating process may be performed through the procedures described in the first embodiment.

The tube 102 of the second embodiment is formed as a two-color molded product, the first synthetic resin base 102a is formed from ABS resin, and the second synthetic resin base 102b is formed from PC resin. In the etching process performed in the Ni electroless plating process, the difference in the synthetic resin properties of the first synthetic resin base 102a and the second synthetic resin base 102b selectively roughens and forms corrugations in the ABS resin surface but does not roughen the PC resin surface and keeps the PC resin surface smooth. The difference in the surface shapes of the synthetic resin bases 102a and 102b subsequent to the etching allows a catalyst to act to deposit Ni ions and form the Ni electroless plating layer 121 on the ABS resin surface of the first synthetic resin base 102a. In this manner, the Ni electroless plating layer 121 is selectively formed on only the first synthetic resin base 102a, and conductivity is added to only the first synthetic resin base 102a.

Then, an electroplating process is performed to form the metal plating layer 122 on the Ni electroless plating layer 121 to add ornamentality. In the second embodiment, an Sn bright plating process is performed to add suitable luster to the outer appearance of the knob 100. The Sn bright plating process can be performed in a plating bath containing a brightening agent and Sn through a method known in the art.

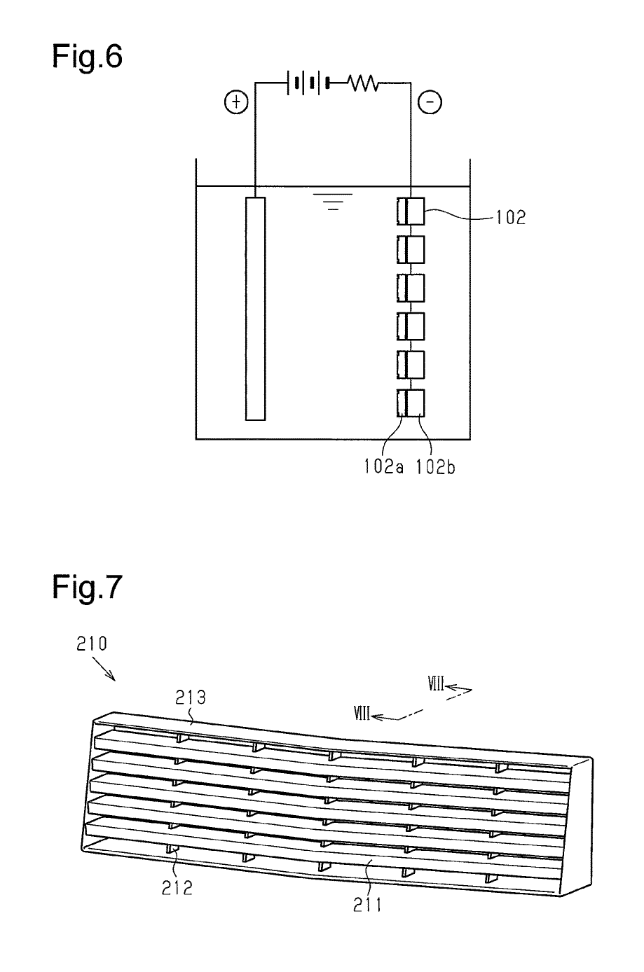

As shown in FIG. 6, each of the tubes 102, which includes the Ni electroless plating layer 121 formed on only the first synthetic resin base 102a, is immersed in the plating bath as a cathode. Here, the front surfaces 113 of the first synthetic resin bases 102a of the tubes 102 are arranged next to one another opposing the anode. This plates the metal plating layer 122 (bright Sn plating layer) with the same thickness on each of the tubes 102. Thus, the metal plating layers 122 (bright Sn plating layers) formed on the tubes 102 have a uniform thickness.

The tubes 102 are arranged so that the interval between adjacent ones of the tubes 102 is larger than the length of the corresponding first synthetic resin bases 102a in the front-rear direction. That is, the interval between the outer surfaces 115 of adjacent ones of the tubes 102 is set to be larger than the length of each synthetic resin base 102a in the front-rear direction. This obtains the preferred current density even at the vicinity of the rear end of the inner surface 114 and the outer surface 115 of the first synthetic resin base 102a and obtains the thickness of the metal plating layer 122 (bright Sn plating layer) all the way to the rear end of the first synthetic resin base 102a.

The bright Sn plating bath may be formed through the same method and material as described in, for example, the first embodiment.

The Sn bright plating process selectively forms the metal plating layer 122 (Sn bright plating layer) only on the first synthetic resin base 102a to which conductivity has been added by the Ni electroless plating process.

Then, to further improve the outer shape of the metal plating layer 122 (bright Sn plating layer) and increase the ornamentality of the knob 100, a colorless and transparent synthetic resin layer 123 is formed on the metal plating layer 122 (bright Sn plating layer). This forms a resin film having high level of luster on the surface of the knob 100 and makes the knob 100 look luxurious.

Electrodeposition painting is performed to form the synthetic resin layer 123. Electrodeposition painting may be performed through a method known in the art. Any one of anion electrodeposition painting and cation electrodeposition painting may be performed.

For example, when using a cation electrodeposition paint composition as the electrodeposition paint composition, a voltage of 1 to 400 V is normally applied between the cathode, which is the base, and the anode. When performing electrodeposition painting, the bath liquid of the electrodeposition paint composition is adjusted to 10° C. to 45° C., preferably, 15° to 30° C. The electrodeposition process includes a process for immersing the base in the cation electrodeposition paint composition and a step for applying voltage between the base, which serves as the cathode, and the anode and depositing a film. The application time of voltage and the applied voltage may be in accordance with a method known in the art. After the electrodeposition painting, the tube 102 is irradiated with ultraviolet rays, and a cross-linking treatment is performed on the resin film formed on the surface of the first synthetic resin base 102a to harden the resin film and form the synthetic resin layer 123.

The electrodeposition paint composition may be one that is used in the prior art. For example, the electrodeposition paint composition may be the one that is used in the first embodiment.

In the same manner as the Sn bright plating process, during the electrodeposition painting, as shown in FIG. 6, the front surfaces 113 of the first synthetic resin bases 102a of the tubes 102 are arranged next to one another opposing the anode, and the interval between adjacent ones of the tubes 102 is set to be larger than the length of the first synthetic resin base 102a in the front-rear direction. Thus, the synthetic resin layers 123 formed on the tubes 102 have a uniform thickness. Further, the synthetic resin layer 123 is formed all the way to the rear of the first synthetic resin base 102a.

The electrodeposition painting selectively forms the synthetic resin layer 123 only on the first synthetic resin base 102a, to which conductivity is added by the No electroless plating process and on which the metal plating layer 122 (bright Sn plating layer) is formed. In the outer surface 115 of the outer tube 111 of the tube 102 in the second embodiment, the recess groove 117 is formed between the first synthetic resin base 102a and the second synthetic resin base 102b. This provides a clear boundary between the portion where the ornamental film (Ni electroless plating layer 121, metal plating layer 122, and synthetic resin layer 123) is formed and the portion where the ornamental film is not formed. Thus, the end of the ornamental film is clear. This improves the outer shape.

The operation of the tube 102 of the second embodiment and the method for manufacturing the tube 102 will now be described.

The synthetic resin base of the tube 102 is formed as a two-color molded product. The difference in the properties of the synthetic resin forming the two-color molded product results in the etching process performed during the Ni electroless plating process obtaining different surface shapes. Thus, the affinity to metal differs between the first synthetic resin base 102a and the second synthetic resin base 102b.

By forming the synthetic resin layer 123 through electrodeposition painting, the synthetic resin layer 123 can be selectively formed only on the first synthetic resin base 102a to which conductivity is added among the synthetic resin bases 102a and 102b.

The recess groove 117 formed in the outer surface 115 of the outer tube 111 of the tube 102 acts to space apart the first synthetic resin base 102a from the second synthetic resin base 102b.

The groove 116 in the front surface 113 of the outer tube 111 is formed so that the width W at its opening is larger than the depth H. This shape obtains the preferred current density to the deepest part of the groove 116, and the Sn ions easily reach the deepest part of the groove 116. Further, the electrodeposition paint composition easily reaches the deepest part of the groove 116 during electrodeposition painting.

In the bright Sn plating process and the electrodeposition painting, the front surfaces 113 of the first synthetic resin bases 102a of the tubes 102 are arranged next to one another opposing the anode, and the interval between adjacent ones of the tubes 102 is set to be larger than the length of the corresponding first synthetic resin bases 102a in the front-rear direction. This arrangement acts to obtain the preferred current density at the rear of the first synthetic resin base 102a and ensure that the Sn ions and the electrodeposition paint composition reach the rear of the first synthetic resin base 102a.

The advantages of the tube 102 in the second embodiment and the method for manufacturing the tube 102 will now be described.

(2-1) The synthetic resin base is formed as a two-color molded product. Thus, the surfaces roughened by the etching process are shaped differently, and the ornamental film is selectively formed on only one of the synthetic resin bases 102a. The two-color molded product facilitates the selective formation of the ornamental film.

(2-2) The synthetic resin layer 123 is formed through electrodeposition painting. Thus, the synthetic resin layer 123 is selectively formed on only the conductive portion. This facilitates the formation of the synthetic resin layer 123 and provides a clear boundary between the portion where the synthetic resin layer 123 is formed and the portion where the synthetic resin layer 123 is not formed. Further, electrodeposition painting facilitates the formation of the synthetic resin layer 123 even when the tube 102 has a complicated shape and the synthetic resin layer 123 is a portion difficult to form through spray painting.

(2-3) The recess groove 117 is formed between the first synthetic resin base 102a and the second synthetic resin base 102b. This provides a clear boundary between the portion where the ornamental film is formed and the portion where the ornamental film is not formed, and the ornamentality of the knob 100 is further improved. The recess groove 117 may be referred to as a boundary or a boundary mark.

(2-4) The groove 116 formed in the front surface 113 of the outer tube 111 is formed so that the width W at its opening is larger than the depth H. Thus, the bright Sn plating layer is formed extending into the groove 116. The bright Sn plating layer is uniformly formed in the entire groove 116, and the ornamentality of the knob 100 is improved. Further, the electrodeposition paint composition easily reaches the inside of the groove 116, and the synthetic resin layer 123 is uniformly formed in the entire groove 116.

(2-5) In the bright Sn plating process and the electrodeposition painting, the front surfaces 113 of the first synthetic resin bases 102a of the tubes 102 are arranged next to one another opposing the anode, and the interval between adjacent ones of the tube 102 is set to be larger than the length of the first synthetic resin base 102a in the front-rear direction. Accordingly, the ornamental film is efficiently formed on each of the tubes 102, and a uniform resin film is formed extending to the rear of each first synthetic resin base 102a.

(2-6) The first synthetic resin base 102a is shaped so that there is no undercut portion. Thus, there is no portion where it is difficult to form the ornamental film, and an entirely uniform ornamental film can be formed.

The above embodiment may be modified as described below.

The ornamental plated product of the second embodiment is not limited to a car audio knob tube and may be applied to other components that are ornamental.

The shape of the ornamental plated product is not particularly limited. The metal plating layer 122 is formed through an electroplating process, and the synthetic resin layer 123 is formed through electrodeposition painting. Thus, even when the shape is complicated, metal ions easily reach the electrodeposition paint as long as the preferred current density is obtained.

The tube 102 of the second embodiment includes a step in the second synthetic resin base 102b and a recess groove 117 between the first synthetic resin base 102a and the second synthetic resin base 102b. However, there is no limit to such a structure. The rear end of the first synthetic resin base 102a may include a step, and the rear end of the first synthetic resin base 102a and the front end of the second synthetic resin base 102b may both include a step. Further, the inner surface 114 may include the recess groove 117.

In the tube 102 of the second embodiment, the first synthetic resin base 102a and the second synthetic resin base 102b are tubular and have the same diameter. However, for example, the second synthetic resin base 102b located at the rear may be reduced in diameter to form a step between the outer surface 115 of the first synthetic resin base 102a and the outer surface 115 of second synthetic resin base 102b.

The groove 116 is formed in the front surface 113 of the outer tube 111 in the tube 102 of the second embodiment. However, the groove 116 may be omitted. Alternatively, the shape of the groove 116 may be changed. Instead of the groove 116, a projection may be formed projecting toward the front from the front surface 113.

In the tube 102 of the second embodiment, the groove 116 is formed in the front surface 113 of the outer tube 111, and the width W at is opening is larger than the depth H. Instead, the width W at the opening may be smaller than the depth H or the width W at the opening may be the same as the depth H. In any case, it is preferred that the width W of the opening be larger than the depth of the position where the ornamental film is formed on the inner surface of the groove 116. That is, it is preferred that the interval between the opposing inner surfaces of the groove 116 be set to be larger than the length of the ornamental film on each inner surface. This obtains the preferred current density at the inner surface of the groove 116 and ensures the thickness of the ornamental film on the inner surface of the groove 116.

In the second embodiment, Ni electroless plating is performed to add conductivity to the first synthetic resin base 102a. Instead, an electroless plating process that is known in the art may be performed such as a Co electroless plating process, a Cu electroless plating process, a Pd electroless plating process, an Au electroless plating process, or the like.

In the second embodiment, a bright Sn plating process is performed as a metal plating process that adds ornamentality of the tube 102. Instead, an electroplating process that is known in the art may be performed such as Cr plating, Cu plating, Ni plating, Zn plating, Au plating, Ag plating, and Sn alloy plating.

In the second embodiment, only the Sn bright plating layer is formed as the metal plating layer 122. However, a further metal plating layer 122 may be stacked to form a multilayer structure.

In the second embodiment, a colorless and transparent synthetic resin layer is formed through electrodeposition painting. Instead, a suitable pigment may be contained in the paint composition to form a colored transparent layer, and a non-transparent resin layer may be formed. The desired color tone may be easily obtained from the combination of the metal plating layer 122 and the synthetic resin layer 123.

In the second embodiment, only a colorless and transparent synthetic resin layer is formed as the synthetic resin layer 123. However, a further colored transparent synthetic resin layer may be stacked on a transparent synthetic resin layer to form a multilayer structure.

In the second embodiment, the film after electrodeposition painting is cured when irradiated with ultraviolet rays. Instead, the film may be cured by heat.

An ornamental plated product according to a third embodiment of the present invention will now be described. The ornamental plated product may be a front grille body 210 shown in FIGS. 7 to 9. As shown in FIG. 7, the front grille body 210 includes generally parallel horizontal bars 211 that are arranged at predetermined intervals and held in a tetragonal frame. The horizontal bars 211 form a framework of the front grille body 210. Generally parallel vertical bars 212, which extend perpendicular to the horizontal bars 211, are arranged at predetermined intervals and held by the frame 213.

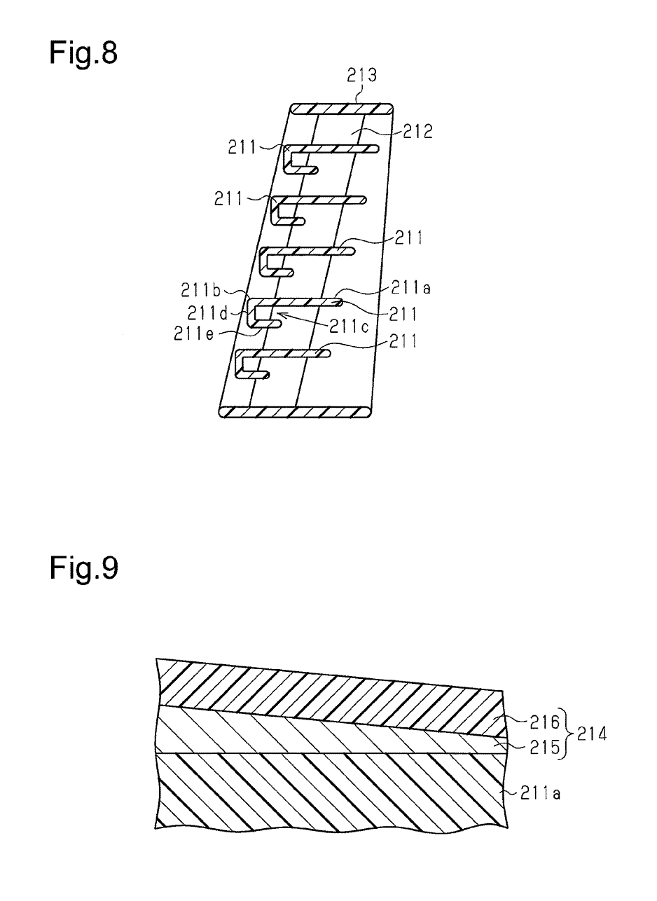

As shown in FIG. 8, each horizontal bar 211 includes a flat plate 211a and a recess 211c, which extends downward from the flat plate 211a and includes a front end 211b located at the front side of the front grille body 210. The recess 211c is molded to be recessed and defined by the front end of the flat plate 211a, a front wall 211d that extends downward from the front end 211b, and a lower wall 211e that extends toward the rear of the front grille body 210 from the lower end of the front wall 211d. The horizontal bars 211 and the vertical bars 212 have curved corners and ends for reasons related to the design property and functionality, such as air intake.

The base of the front grille body 210 in the third embodiment is not particularly limited and may be selected from known materials in accordance with the application. Specific examples of the base include resin, metal, glass, ceramics, and the like. A resin material used for the base may be selected taking into consideration rigidity, processing easiness, heat resistance, functionality such as plating easiness, purpose of use, and the like. Examples of a resin include acrylonitrile butadiene styrene (ABS) resin, polycarbonate (PC) resin, PC/ABS alloy (PC/ABS blend resin), polypropylene (PP) resin, polyacrylic resin (polymethacrylic resin), polymethylmethacrylate (PMMA) resin, modified polyphenylene ether (PPE) resin, polyamide resin, polyacetal resin, and the like. Further, the resin base may be molded through a known molding process, for example, injection molding, extrusion molding, blow molding, compression molding, or the like. Examples of a metal material used for the base include stainless steel, Al, an Al alloy, Ti, a Ti alloy, and the like. One of these materials may be selected and used for the base. Alternatively, more than one of these materials may be used in combination.

As shown in FIG. 9, a plating process is performed to form a plating layer 214 on the entire surface of the front grille body 210. The plating layer 214 includes an ornamental metal plating layer 215, which is stacked on the surface of the base including the flat plate 211a of the front grille body 210, and a synthetic resin layer 216, which is directly stacked on the metal plating layer 215. The metal plating layer 215 is formed through electroplating. When performing an electroplating process, conductivity is added to the base surface. Thus, an electroless plating process needs to be performed before performing an electroplating process. The electroless plating process may be a Cu electroless plating process or an Ni electroless plating process.

A known method may be employed as the Cu electroless plating process or the Ni electroless plating process. For example, the same procedures as the first embodiment may be performed.

The material for the metal plating layer 215 is not particularly limited as long as metallic luster can be added as ornamentality to the base through an electroplating process. Examples of such material include Ni, Cu, Cr, Sn, and an Sr alloy. One of these materials may be selected and used for the metal plating layer 215. Alternatively, more than one of these materials may be used in combination. Among these materials, Cr, Sn, and Sn alloy are preferred taking into consideration improvement in the functionality, such as durability, and outer appearance characteristics, such as the addition of a metallic luster.

A known method may be employed as the Cu electroplating process. For example, the same process as the first embodiment may be employed. For example, when using a copper sulfate plating bath, an electroplating process may be performed under the conditions in which the temperature of the plating bath is 20° C. to 50° C., and the current density is 1 to 30 A/dm².

A known method may be employed as the Ni plating process. For example, the Ni plating process may be employed using a Watts bath, an all-chloride bath, a sulfamic bath, a Wood's strike bath, or the like. The plating bath may contain a known brightening agent that is applicable to the Ni plating process taking into consideration the addition of luster to the Ni plating layer. For example, when using a Wood's strike bath, an electroplating process may be performed under the conditions in which the pH is 3.8 to 4.6, the processing temperature is 50° C. to 60° C., and the current density is 1 to 6 A/dm².

A known method may be employed as the Cr plating process. For example, the Cr plating process may be employed using a Sargent bath, a fluoride bath (silicofluoride bath, SRHS bath), a high-speed bath, a tetra-chromate bath, a trivalent Cr bath, high-hardness Cr plating bath (Cr—C alloy plating bath), or the like.

The Cr plating process may employ a Co—Cr alloy that is Co-rich to form a black plating film. This increases the blackness as the content amount of cobalt oxide increases. Thus, an oxidation process subsequent to the formation of a Co—Cr film generates cobalt oxide and forms a black plating layer (cobalt oxide layer) that is jet-black. Accordingly, it is preferred that the film composition of the Co—Cr alloy be 50% to 98% in metal amount (mass) relative to the entire Co—Cr. A trivalent Cr compound is selected and used as the Cr compound for a Co—Cr alloy electrolytic process. Specific examples include chromium sulfate, chromium alum, chromium nitrate, chromium chloride, chromium acetate, and the like. Further, a Co compound may also be selected and used. Specific examples include cobalt nitrate, cobalt sulfate, cobalt chloride, and the like. The liquid composition of the Cr compound and the Co compound contained in the electrolytic processing solution may be selected and combined from the compounds exemplified above in accordance with the required degree of blackening. It is preferred that these compounds be in a liquid composition in metal amount of approximately 0.1 to 50 g/L, in particular, approximately 1 to 40 g/L. Further, in the same manner as a normal electrolytic plating process, a conductive salt, a pH buffering agent, a surface conditioner, and the like may be added to the electrolytic processing solution. The electrolytic plating processing may be performed in compliance with a known wet electrolytic plating process. For example, the electrolytic plating process may be performed under the conditions in which the plating bath is in a pH range of 3 to 3.8, the bath temperature is in the range of 40° C. to 60° C., and the current density is in the range of 1 to 20 A/dm².

The Sn or An alloy plating process may be performed using, for example, the same method and materials as that described in the first embodiment. When employing an organic sulfonic acid bath, tin(II) sulfate, cresol sulfonic acid, a formalin compound (formaldehyde), an amine-aldehyde brightening agent, a surfactant, a pH adjustor, and the like may be dissolved in a methanesulfonic acid bath. An electroplating process is performed on the methanesulfonic acid bath under the conditions in which the processing temperature is 10° C. to 60° C., and the current density is 1 to 5 A/dm².

When an Sn or Sn alloy plating process is used as the metal plating layer 215, the Sn plating bath or Sn alloy plating bath may contain a brightening agent to add luster to the outer appearance of the base. The brightening agent may be one that is known in the art. Specific examples and the added amount are as described in the first embodiment.

FIG. 9 shows the thickness profile of the metal plating layer 215. The metal plating layer 215 has a non-uniform thickness profile in which a first portion has a first thickness, a second portion has a second thickness that is smaller than the first thickness, and a middle portion between the first portion and the second portion has a thickness that decreases in a sloped manner. In the electroplating process step, the thickness profile of the metal plating layer 215 may be adjusted by changing the distance between the base and the electrode in a sloped manner. For example, an electroplating process is performed when the first portion of the base is arranged at a position separated from the electrode by a first distance and the second portion of the base is separated from the electrode by a second distance that is longer than the first distance to form the metal plating layer 215 with the thickness profile of FIG. 9. When an electroplating process is performed on the front grille body 210 that has a grid structure or a multi-recess structure, the voltage is low, particularly, at the rear portion between opposing flat plates 211a and at a surface layer located deep in each recess 211c since the electrode is not near during the electroplating process. Thus, at the surface layer portion that is far from the electrode, the metal plating layer 215 is thinner than that at the surface portion that is close to the electrode like the front wall 211d. The lower limit of the thickness of the metal plating layer 215 at the thinnest portion that is farthest from the electrode is 0.03 μm or greater, preferably 0.05 μm or greater, and more preferably 0.1 μm or greater. When the thickness is 0.03 μm or greater, a metallic luster can be added to the base. Further, the synthetic resin layer 216 can be formed through electrodeposition painting, which will be described later. The upper limit of the thickness of the metal plating layer 215 is not particularly limited since the metal plating layer 215 need only be formed to have a predetermined thickness or greater on the entire surface of the front grille body 210. When taking into consideration productivity such as the manufacturing cost, the thickness at the thickest portion that is farthest from the electrode is preferably 50 μm or less, more preferably 40 μm or less, and further preferably 30 μm or less.

The synthetic resin layer 216 is stacked on the surface of the metal plating layer 215 to add corrosion resistance and adjust the color tone. A known synthetic resin layer used to protect a plating surface may be employed as the synthetic resin layer 216. Taking into consideration the visibility of the metal plating layer 215, the synthetic resin layer 216 is transparent or translucent. A translucent synthetic resin layer need only be transparent enough to allow the design of the metal plating layer to be seen through the synthetic resin layer when viewed from the upper side. The transparent or translucent synthetic resin layer 216 adds corrosion resistance to the metal plating layer 215 and achieves a sufficient ornamental effect. The synthetic resin layer 216 may contain a coloring agent such as a pigment or a dye to add color and further improve the design property and ornamentality.

The method for applying a coating agent used to form the synthetic resin layer 216 is, for example, electrodeposition painting and the same as the first embodiment. The electrodeposition painting forms the synthetic resin layer 216 with a predetermined thickness on the metal plating layer 215. This forms a plating layer having superior functionality, such as corrosion resistance and durability, and superior outer appearance characteristics. When performing electrodeposition painting, the front grille body 210 is placed in a vessel containing paint, and electrophoresis is performed with the front grille body 210 entirely immersed in the paint. This forms the synthetic resin layer 216, which has a predetermined thickness profile, in the surface of the front grille body 210 where the metal plating layer 215 is formed. The resin used to form the synthetic resin layer 216 may be of a single type or a combination of multiple types.

The thickness of the synthetic resin layer 216 is not particularly limited as long as a protection function can be obtained and the design of the metal plating layer 215 can be seen through the synthetic resin layer 216 when viewed from above. The lower limit of the thickness of the synthetic resin layer 216 is preferably 5 μm or greater, more preferably 7 μm or greater, and further preferably 10 μm or greater. When the thickness is 5 μm or greater, functionality such as durability is further improved. The upper limit of the synthetic resin layer 216 is preferably 30 μm or less, more preferably 25 μm or less, and further preferably 20 μm or less. When the thickness is 30 μm or less, the productivity can be improved. Further, the visibility of the metal plating layer 215 can be further improved.

The front grille body 210 of the third embodiment has the advantages described below.

(3-1) In the third embodiment, the front grille body 210 has a grid structure or a multiple-recess structure and entirely undergoes electroplating to form the metal plating layer 215, which is ornamental and has a thinnest portion of 0.03 μm. Electrodeposition painting is further performed to form the transparent or translucent synthetic resin layer 216 on the metal plating layer 215. In the entire surface of the ornamental plated product having a complicated grid structure of the like, each plating layer provides sufficient outer appearance characteristics and functionality such as chipping resistance and corrosion resistance.

(3-2) In the third embodiment, it is preferred that the synthetic resin layer 216 be 5 μm or greater. This further improves the functionality such as durability.

(3-3) In the third embodiment, it is preferred that the metal plating layer 215 be formed from at least one of Ni, Cu, Cr, Sn, and an Sn alloy. This adds a metallic luster to the surface of the front grille body 210 and further improves ornamentality.

(3-4) In the step of the electroplating process, the difference in the distance from the electrode produces a difference in the thickness of the metal plating layer 215 on the front grille body 210. When an electroplating process is performed on the front grille body 210 that has a grid structure or a multi-recess structure, the electrode is far. Thus, the voltage is low, particularly, at the rear portion between the flat plates 211a and at a surface layer located deep in each recess 211c. Consequently, at the surface layer portion that is far from the electrode, the metal plating layer 215 is thinner than that at the surface portion that is close to the electrode. The electrodeposition painting forms the synthetic resin layer 216 that has a predetermined thickness. This obtains sufficient outer appearance characteristics and functionality with the synthetic resin layer 216.

The above embodiment may be modified as described below.

The third embodiment is applied to a plating process of a front grille body 210 serving as an ornamental plated product. However, the type of the ornamental plated product is not particularly limited, and the ornamental plated product may be applied to interior and exterior vehicle components, electric and electronic components, and the field of daily commodities or the like.

The ornamental plated product of the third embodiment is the front grille body 210 having a grid structure or a multiple-recess structure. However, the ornamental plated product may be a front grille body including a ladder structure formed by the frame 213 and the horizontal bars 211 instead of or in addition to the vertical bars 212. The ornamental plated product may be a front grille body from which the frame 213 is omitted and formed by the horizontal bars 211 and one or more of the vertical bars 212.

The ornamental plated product of the third embodiment need only have one of a ladder structure, a grid structure, and a multiple-recess structure.

The third embodiment forms the plating layer 214 on the entire surface of the ornamental plated product. However, during a plating process, the surface of the ornamental plated product may include portions where the plating layer is not formed so that such portions can be used to hold or support the ornamental plated product.

In the third embodiment, when performing an electroplating process on the base, Ni and Cu electroless plating processes are performed as pre-processes. However, processes other than such plating processes may be performed.

In the third embodiment, the conditions such as the temperature and time of each plating process may be set taking into consideration productivity or the like.

In the third embodiment, the metal plating layer 215 covers the base. The Cu plating layer is formed as an underlayer on the base, and a metal plating layer 215 other than a Cu plating layer is formed thereon. When a Cu plating layer is stacked on the base, superior ductility is obtained. Accordingly, the difference in the linear expansion coefficient between the metal plating and the base absorbs stress and improves the durability and adhesion between layers.

An Ni plating process, for example, an Ni (SBN) semi-bright plating process, an Ni (Bn) bright plating process, a dull Ni (DN) plating process, or the like may be performed on the Cu plating layer, which serves as the underlayer. In particular, when Cr plating is employed for the metal plating layer 215, the Ni plating layer further restricts corrosion and improves the durability of the ornamental plated product.

### EXAMPLES

Examples and comparative examples will now be given to describe the third embodiment in further detail. The present invention is not limited to each example.

### Test Example 1

### Evaluation Test of Outer Appearance Characteristics and Functionality of Ornamental Plated Product that has Undergone Plating Process

Under the conditions recited in the examples described below, a commercially available hull cell kit (manufactured by Yamamoto-MS Co., Ltd.) was used. Each metal plating process was performed using an ABS resin plate having a predetermined length as a sample piece assumed as an ornamental plated product. Further, the same hull cell kit was used to form a synthetic resin layer on the metal plating layer through electrodeposition. The surface of the sample piece obtained in each test was observed, and the corrosion resistance was evaluated as the functionality and the luster of the outer appearance surface was evaluated as the outer appearance characteristic for each predetermined distance from the electrode in accordance with the plating thickness and the method described below.

### Example 1

An ABS resin plate having a length of 80 mm was prepared and pre-processed to add conductivity to the surface of the resin plate. In the pre-processing, an etching process was performed by immersing the ABS resin plate in chromium acid. After adding a metal complex of PD-Sn to the etched surface and activating the metal complex, an Ni electroless plating process was performed to form an Ni film, which serves as a conductor, on the surface of the ABS resin plate.

A Cu plating layer and an Ni plating layer, each having a thickness of 10 μm was stacked as underlayers through a known electroplating process on the surface of the ABS resin to which conductivity was added in the pre-process. A hexavalent Cr plating layer was formed as a metal plating layer on the surface of the obtained underlayer. The hexavalent Cr plating process was performed in a Sargent bath. A commercially available product was used as the hexavalent Cr plating bath. The plating bath contained 200 to 300 g/L of chromic anhydride (chromium oxide (VI)), 2 to 3 g/L of sulfuric acid, and the like. The temperature of the plating bath was 40° C. to 50° C., and the plating time was two minutes. The thickness of the hexavalent Cr plating layer was measured at predetermined distances from the electrode on the surface of the obtained sample piece.

Electrodeposition painting was then performed on the hexavalent Cr plating layer to form a synthetic resin layer. The hull set test kit, which was used when forming the metal plating layer, was used as the painting device of the electrodeposition painting. A commercially available product can be used as the resin paint for electrodeposition painting. For example, an electrodeposition paint composition that was used included film formation components of ultraviolet curing (meth)acrylic resin containing a (meth)acryloyl group, an acrylic derivative containing isocyanate (polyfunctional (meth)acrylate), a photopolymerization initiator, and the like. As the electrodeposition painting conditions, the liquid temperature was 25° C. and the painting time was one minute. Subsequent to the electrodeposition painting process, a UV dryer (80 W, two lamps, metal halide lamp, distance of 20 cm) was used to irradiate the film for one minute and harden the film to form a synthetic resin layer. The thickness of the synthetic resin layer was measured at predetermined distances from the electrode on the surface of the obtained sample piece.

Corrosion Resistance

Evaluation was performed using the CASS test (JISH8502). More specifically, the obtained sample piece was placed in a CASS test tank containing an NaCl/CuCl₂ test liquid adjusted to pH 3.0 with acetic acid for 50 hours under the condition in which the test tank temperature was 50° C. and the humidity was 65%. Then, the sample piece was removed from the tank, and evaluations were visually made at predetermined distances from the electrode on the sample surface with regard to changes in the surface state such as color change, stain, corrosion, surface deterioration, and delamination.

Circle: no change in surface state, practicability is high

Triangle: Slight change in surface state, practicability is minimum level

Cross: Change in surface state, practicability is low

<Luster of Outer Appearance>

The luster of the outer appearance derived from the metal plating layer of the sample piece was visually evaluated at predetermined distances from the electrode on the sample piece surface in accordance with the reference shown below by an evaluator under a standard light source.

Circle: superior luster, practicability is high

Triangle: slightly inferior luster, practicability is minimum level

Cross: no luster, practicability is low

TABLE 1

| | | Hexavalent | | | |
|---|---|---|---|---|---|
| Distance | | Chromium | Electro- | | |
| from | Current | Plating | deposition | | Outer |
| Electrode | Density | Layer | Painting | Corrosion | Appearance |
| (mm) | (A/dm²) | (μm) | (μm) | Resistance | Luster |
| 50 | 7.2 | 0.25 | 19 | ∘ | ∘ |
| 60 | 5.1 | 0.16 | 18 | ∘ | ∘ |
| 70 | 3.4 | 0.1 | 16 | ∘ | ∘ |
| 80 | 1.8 | 0.05 | 13 | ∘ | ∘ |

It can be understood from table 1 that the difference in the distance from the electrode during the electroplating process reduces the thickness of the hexavalent chromium plating layer at locations farther from the electrode. However, the electrodeposition painting can further cover the synthetic resin layer, which has a predetermined thickness. Thus, even when the ornamental plated product has a complicated structure such as a grid structure, a plating layer can be formed having the required functionality such as corrosion resistance and the required outer appearance characteristics such as luster of the outer appearance regardless of the distance from the electrode.

### Example 2

An ABS resin plate having a length of 60 mm was prepared, and a Cu and Ni plating layer were each stacked as underlayers through the same method as example 1 to obtain an ABS resin plate. A trivalent Cr plating layer was formed as a metal plating layer on the ABS resin base including the obtained underlayers. The trivalent Cr plating process was performed in a trivalent Cr bath. A commercially available product was used as trivalent Cr bath. In addition to 100 to 300 g/L of chromium (III) chloride hexahydrate, the plating bath contained the additives of boric acid, glycine, ammonium chloride, aluminum chloride hexahydrate, and the like. The temperature of the plating bath was 35° C. to 65° C., and the plating time was two minutes. The thickness of the trivalent Cr plating layer was measured at predetermined distances from the electrode on the surface of the obtained sample piece.

Then, electrodeposition painting was performed to form a synthetic resin layer on the trivalent Cr plating layer using the same method as example 1. The thickness of the synthetic resin layer was measured at predetermined distances from the electrode on the surface of the obtained sample piece. Further, the corrosion resistance was evaluated as the functionality and the luster of the outer appearance was evaluated as the outer appearance characteristic in the same manner as example 1.

TABLE 2

| | | Trivalent | | | |
|---|---|---|---|---|---|
| Distance | | Chromium | Electro- | | |
| from | Current | Plating | deposition | | Outer |
| Electrode | Density | Layer | Painting | Corrosion | Appearance |
| (mm) | (A/dm²) | (μm) | (μm) | Resistance | Luster |
| 50 | 7.2 | 0.07 | 19 | ∘ | ∘ |
| 60 | 5.1 | 0.03 | 18 | ∘ | ∘ |

It can be understood from table 2 that the difference in the distance from the electrode during the electroplating process reduces the thickness of the trivalent Cr plating layer at locations farther from the electrode. However, the electrodeposition painting can further cover the synthetic resin layer, which has a predetermined thickness. Thus, even when the ornamental plated product has a complicated structure such as a grid structure, a plating layer can be formed having the required functionality such as corrosion resistance and the required outer appearance characteristics such as luster of the outer appearance regardless of the distance from the electrode.

### Example 3

An ABS resin plate having a length of 80 mm was prepared, and a Cu and Ni plating layer were each stacked as underlayers through the same method as example 1 to obtain an ABS resin plate. A Co—Cr plating layer (black trivalent Cr plating layer) was formed as a metal plating layer on the ABS resin base including the obtained underlayers. The electrolytic solution was a sulfate solution having a Cr³⁺ metal amount concentration of 30 g/L and a Co²⁺ metal amount concentration of 3 g/L and also containing a conductive salt, a pH buffering agent, a surface conditioner, and the like. The Co—Cr bath had a temperature of 50° C. and the pH was 3.5 when performing an electrolytic plating for two minutes to form a black plating layer including a Co—Cr alloy layer.

Then, the ABS resin plate having the black plating layer stacked on the surface thereof was removed, and an acid dipping process was performed on the surface to form a cobalt oxide layer. The acid dipping process was performed by immersing the ABS resin plate in a processing tank filled with an organic acid of pH 1.5 at a processing temperature of 50° C. for ten minutes. The acid dipping process caused the advancement of oxidation at the surface layer portion of the Co—Cr alloy layer, which was the black plating layer, and formed the cobalt oxide layer. This increased the blackness of the surface layer portion and obtained a jet-black color tone. Finally, the ABS resin plate was immersed in a chromic anhydride solution and passivated. The dipping process in the chromic anhydride solution of 25 mass % was performed for five minutes under the conditions in which the liquid temperature was 40° C., and the current density was 0.5 A/dm². The composition ratio of the obtained Co—Cr plating layer was Co 90% and Cr 5% in metal mass and also included carbon, oxygen, sulfur, and the like. The thickness of the Co—Cr plating layer was measured at predetermined distances from the electrode on the surface of the obtained sample piece.

Then, electrodeposition painting was performed to form a synthetic resin layer on the C0-Cr plating layer in the same manner as example 1. The thickness of the synthetic resin layer was measured at predetermined distances from the electrode on the surface of the obtained sample piece. Further, the corrosion resistance was evaluated as the functionality and the luster of the outer appearance was evaluated as the outer appearance characteristic in the same manner as example 1.

TABLE 3

| | | Hexavalent | | | |
|---|---|---|---|---|---|
| Distance | | Chromium | Electro- | | |
| from | Current | Plating | deposition | | Outer |
| Electrode | Density | Layer | Painting | Corrosion | Appearance |
| (mm) | (A/dm²) | (μm) | (μm) | Resistance | Luster |
| 50 | 7.2 | 0.23 | 19 | ∘ | ∘ |
| 60 | 5.1 | 0.16 | 18 | ∘ | ∘ |
| 70 | 3.4 | 0.07 | 16 | ∘ | ∘ |
| 80 | 1.8 | 0.03 | 13 | ∘ | ∘ |

It can be understood from table 3 that the difference in the distance from the electrode during the electroplating process reduces the thickness of the black trivalent Cr plating layer at locations farther from the electrode. However, the electrodeposition painting can further cover the synthetic resin layer, which has a predetermined thickness. Thus, even when the ornamental plated product has a complicated structure such as a grid structure, a plating layer can be formed having the required functionality such as corrosion resistance and the required outer appearance characteristics such as luster of the outer appearance regardless of the distance from the electrode.

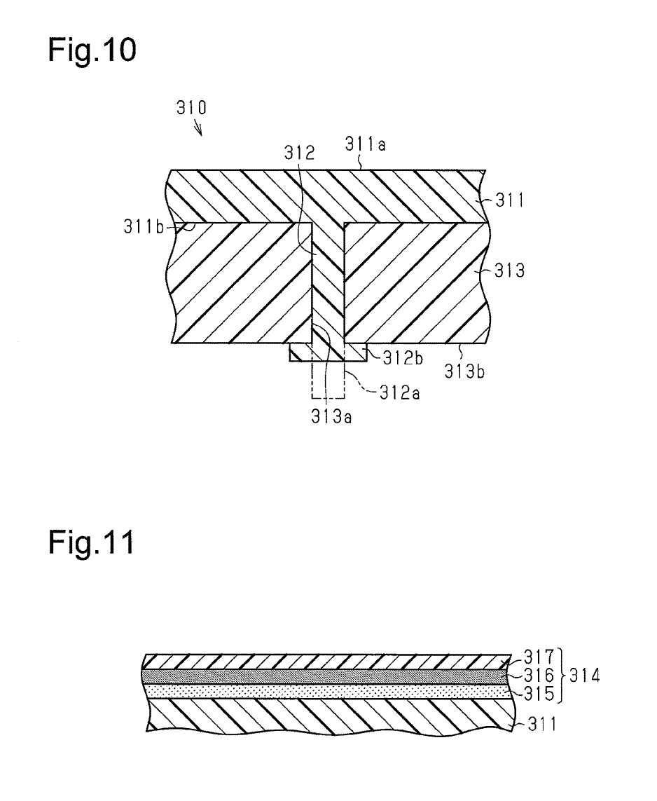

A fourth embodiment of the present invention will now be described with reference to FIGS. 10 and 11.

As shown in FIG. 10, an ornamental plated product 310 of the fourth embodiment includes a base 311 having an ornamental surface 311a and a rear surface 311b. In the illustrated example, a plating process is performed to form the ornamental surface 311a on the upper surface of the base 311. The ornamental surface 311a may be referred to as the ornamental portion. The ornamental plated product 310 includes a post-shaped coupling portion 312 extending in a generally vertical manner from the rear surface 311b of the base 311. The coupling portion 312 is formed from a resin and may be molded integrally with the base 311. When coupling the ornamental plated product 310 to a mount 313, the distal end 312a of the coupling portion 312 is inserted through a coupling hole 313a of the mount 313 and projected out of the rear surface 313b of the mount 313. The distal end 312a is formed from a resin that is fusible and deformable when fixing the ornamental plated product 310 to the mount 313. The distal end 312a projecting out of the rear surface 313b of the mount 313 is fused and deformed when fixing the ornamental plated product 310 to the mount 313. This forms a large diameter portion 312b having a larger diameter than the inner diameter of the coupling hole 313a to restrict separation from the coupling hole 313a. The distal end 312a and/or the large diameter portion 312b may be referred to as a synthetic resin engagement portion or a fusing portion that is fusible and deformable and engaged with the mount 313.

Although not particularly limited, it is preferred that the resin of the coupling portion 312 excluding the base 311 and the distal end 312a be molded from the same resin as the distal end 312a when taking into consideration productivity.

The fusible and deformable resin is not particularly limited and may be selected from a known material in accordance with the application. An example of such as resin is thermoplastic resin. Specific examples of a fusible and deformable resin include ABS resin, polycarbonate (PC) resin, PC/ABS alloy (PC/ABS blend resin), polypropylene (PP) resin, polyacrylic resin (polymethacrylic resin), polymethylmethacrylate (PMMA) resin, modified polyphenylene ether (PPE) resin, polyamide resin, polyacetal resin, and the like. One of these resins may be selected. Alternatively, more than one of these resins may be used in combination.

As shown in FIG. 11, a plating layer 314 is formed on the entire surface of the ornamental plated product 310 of the fourth embodiment. The plating layer 314 includes a Cu plating layer 315 stacked on the surface of the base 311, an Sn or Sn alloy plating layer 316 directly stacked on the Cu plating layer 315, and a synthetic resin layer 317 stacked on the Sn or Sn alloy plating layer 316. In the illustrated example, the synthetic resin layer 317 is an outermost layer of the ornamental plated product 310 and may be referred to as the protection layer.

The Cu plating layer 315 may be manufactured through, for example, the same method as that described in the first embodiment.

The thickness of the Cu plating layer 315 on the base 311 may be set taking into consideration easiness of fusing deformation, ductility, surface accuracy, surface hardness, productivity, and the like. However, the lower limit of the thickness of the Cu plating layer 315 on the base 311 is preferably 5 μm or greater, more preferably 6 μm or greater, and further preferably 7 μm or greater. When the thickness is 5 μm or greater, the functionality of the base 311, such as ductility and surface hardness, and the outer appearance characteristics of the base 311, such as surface accuracy, can be further improved. The upper limit of the thickness of the Cu plating layer 315 is preferably 30 μm or less, more preferably 25 μm or less, and further preferably 20 μm or less. When the thickness is 30 μm or less, the productivity can be improved, for example, the fusing-deforming process of the distal end 312a including the plating layer 314 can be performed further easily.

In the ornamental plated product 310 of the fourth embodiment, the Sn or Sn alloy plating layer 316 is directly stacked on the Cu plating layer 315. The Sn or Sn alloy plating layer 316 has a lower hardness than Cr plating. This further facilitates the fusing-deforming process of the distal end 312a including the plating layer 314. Further, the Sn or Sn alloy plating layer 316 can add a metallic luster to the outer appearance of the ornamental surface 311a of the ornamental plated product 310 as if a Cr plating process has been applied. The Sn or Sn alloy plating layer 316 may be formed from, for example, the same material as that described in the first embodiment.

The Sn or Sn alloy plating process may be performed through, for example, the same method as that described in the first embodiment. For example, when employing an organic sulfonic acid bath, stannous sulphate, cresol sulfonic acid, a formalin compound (formaldehyde), an amine-aldehyde brightening agent, a surfactant, a pH adjustor, and the like may be dissolved in a methanesulfonic acid bath. An electroplating process is performed on the methanesulfonic acid bath under the conditions in which the processing temperature is 10° C. to 60° C., and the current density is 1 to 5 A/dm².

The thickness of the Sn or Sn alloy plating layer 316 stacked on the Cu plating layer 315 may be set taking into consideration easiness of fusing deformation, the outer appearance characteristics such as the color tone and the surface accuracy of the ornamental surface 311a, the outer appearance characteristic such as the surface roughness, productivity, type of Sn alloy, and the like. For example, in an Sn or Sn—Ni alloy plating, the lower limit of the thickness of the plating layer is preferably 1 μm or greater, more preferably 3 μm or greater, and further preferably 5 μm or greater. When the thickness is 1 μm or greater, the preferred outer appearance characteristics can be obtained. The upper limit of the thickness of the plating layer is preferably 30 μm or less, more preferably 25 μm or less, and further preferably 20 μm or less. When the thickness is 30 μm or less, the productivity can be improved, for example, the fusing-deforming process of the distal end 312a including the plating layer 314 can be performed further easily.

Further, for example, when using an Sn—Co alloy plating, the lower limit of the thickness of the plating layer is preferably 0.1 μm or greater, more preferably 0.2 μm or greater, and further preferably 0.3 μm or greater. When the thickness is 0.1 μm or greater, the preferred outer appearance characteristics can be obtained for the ornamental surface 311a. The upper limit of the thickness of the plating layer is preferably 1 μm or less, more preferably 0.9 μm or less, and further preferably 0.8 μm or less. When the thickness is 1 μm or less, the productivity can be improved, for example, the fusing-deforming process of the distal end 312a including the plating layer 314 can be performed further easily.

An Sn plating bath or an Sn alloy plating bath may contain a brightening agent to add luster to the outer appearance of the base 311 with the Sn or Sn alloy plating layer 316. The brightening agent may be one that is known in the art. Specific examples and the added amount are as described in the first embodiment.

The synthetic resin layer 317 is formed on the upper surface of the Sn or Sn alloy plating layer 316 to enable fusing and deformation of the resin distal end 312a where a metal plating layer is formed. The synthetic resin layer 317 improves the functionality such as the corrosion resistance. The resin of the synthetic resin layer 317 is a resin that is fusible and deformable together with the distal end 312a when the distal end 312a is fused and deformed to fix the ornamental plated product 310 to the mount 313. Preferably, the glass transition temperature is 25° C. or greater and less than or equal to the fusing-deforming temperature of the distal end 312a. When the glass transition temperature of the resin is 25° C. or greater, the functionality of the ornamental plated product can be maintained when used under room temperature. When the glass transition temperature of the resin is less than the fusing-deforming temperature of the distal end 312a, the fusing and deforming process can be easily performed on the distal end 312a. When the glass transition temperature of the resin is 25° C. or greater, the functionality of the ornamental plated product can be maintained under room temperature. When the glass transition temperature of the resin is less than or equal to the fusing-deforming temperature of the distal end 312a, the fusing and deforming process can be easily performed on the distal end 312a.

It is further preferred that the synthetic resin layer 317 be a transparent or translucent synthetic resin layer to ensure that the Sn or Sn alloy plating layer 316 is visible and to further improve the outer appearance characteristics. The translucent synthetic resin layer need only be transparent enough to allow the design of the Sn or Sn alloy plating layer 316 to be seen through the synthetic resin layer 317 when seen from above. The transparent or translucent synthetic resin layer 317 improves the functionality, such as corrosion resistance, of the Sn or Sn alloy resistance and has sufficient outer appearance characteristics, such as an ornamental effect.

Examples of the resin used to form the synthetic resin layer 317 include an acrylic resin (methacrylic resin), polycarbonate resin, urethane resin, and melamine resin. Among these resins, ultraviolet curing polyfunctional acrylic resin is preferred since it has superior corrosion resistance, chemical resistance, abrasion resistance, ductility, transparency, and handling characteristics. One of these resins may be selected and used. Alternatively, more than one of these resins may be used in combination.

The synthetic resin layer 317 may be formed, for example, using the same method and the same material as the first embodiment. When performing electrodeposition painting, the ornamental plated product 310 is placed in a vessel containing paint, and electrophoresis is performed with the ornamental plated product 310 entirely immersed in the paint. This forms an integrated synthetic resin layer with a resin paint film on the ornamental surface of the ornamental plated product 310 and the distal end 312a of the coupling portion 312.

The thickness of the synthetic resin layer 317 on the Sn or Sn alloy plating layer 316 is not particularly limited as long as the fusing and deforming process can be performed. When the synthetic resin layer 317 is transparent or translucent, it is preferred that the synthetic resin layer 317 have a thickness that provides a protection function for the ornamental surface 311a and allows the design of the Sn or Sn alloy plating layer 316 to be seen through the synthetic resin layer 317 when viewed from above. The lower limit of the thickness of the synthetic resin layer 317 is preferably 5 μm or greater, more preferably 6 μm or greater, and further preferably 7 μm or greater. When the thickness is 5 μm or greater, the protection function for the underlayer can be improved. The upper limit of the thickness of the synthetic resin layer 317 is preferably 30 μm or less, more preferably 25 μm or less, and further preferably 20 μm or less. When the thickness is 30 μm or less, the productivity can be improved, for example, the fusing-deforming process of the distal end 312a including the plating layer 314 can be performed further easily. Further, when the synthetic resin layer 317 is transparent or translucent, the visibility of the Sn or Sn alloy plating layer 316 can be further improved.

The operation of the ornamental plated product 310 of the fourth embodiment will now be described.

The entire ornamental plated product 310 of the fourth embodiment including the ornamental surface 311a and the surface of the distal end 312a first undergoes an integral plating process to form the plating layer 314 in a continuous manner. The plating layer 314 is stacked on the entire surface of the ornamental plated product. When coupling the ornamental plated product 310 to the mount 313, the post-shaped coupling portion is inserted through the coupling hole 313a, and the distal end 312a is projected out of the rear surface 313b of the mount 313. A known method is used to perform a fusing-deforming process, for example, a resin swaging process, and flatten the distal end 312a in order to form the large diameter portion 312b, which has a larger diameter than the coupling hole 313a. Separation of the coupling portion 312 from the coupling hole 313a is restricted, and the ornamental plated product 310 is fixed to the mount 313. In this manner, the ornamental plated product 310, in which the plating layer 314 is formed on the ornamental surface 311a, is fixed to the mount 313 by the coupling portion 312, and a design property is added to the mount 313.

When performing a fusing-deforming process, for example, a resin swaging process, the synthetic resin layer 317 covering the distal end 312a extends around the metal plating layer that includes the Cu plating layer 315 and the Sn or Sn alloy plating layer 316. Further, the synthetic resin layer 317 is deformed integrally with the resin forming of the distal end 312a. The Cu plating layer 315 and the Sn or Sn alloy plating layer 316 has superior ductility and a lower hardness than a Cr plating. This allows for reduction in thickness as compared with the prior art that sequentially performs Su, Ni, and Cr plating processes. Thus, the distal end 312a, which undergoes a plating process, is deformed integrally with the plating layer 314 and the resin of the distal end 312a in a further facilitated manner.

The ornamental plated product 310 of the fourth embodiment has the advantages described below.

(4-1) In the fourth embodiment, the plating layer 314 of the ornamental plated product 310 includes the Cu plating layer 315, the Sn or Sn alloy plating layer 316 directly stacked on the Cu plating layer 315, and the synthetic resin layer 317 stacked on the Sn or Sn alloy plating layer 316. Accordingly, when coupling the ornamental plated product 310 to the mount 313, the distal end 312a on which the plating layer 314 is stacked can be fused and deformed. The plating layer 314, in which the synthetic resin layer 317 is stacked on the surface of a metal plating layer, continuously extends from the ornamental surface 311a to the surface of the distal end 312a as a result of an integral plating process. Thus, when a plating process is performed, masking of the distal end 312a can be omitted, and productivity can be improved.

(4-2) In the fourth embodiment, the plating layer 314 includes the Cu plating layer 315 on the base 311. Accordingly, the Cu plating layer 315 has superior ductility. This absorbs the stress produced by the difference in the linear expansion coefficient from the metal plating relative to the base 311 and improves the functionality, in particular, the durability and adhesion between layers. Further, the plating bath contains a leveling agent, an accelerator, an inhibitor, and the like to improve the outer appearance characteristics, in particular, the surface accuracy of the Cu plating film.

(4-3) In the fourth embodiment, the Sn or Sn alloy plating layer 316 is directly stacked on the Cu plating layer 315 in the plating layer 314. Accordingly, superior outer appearance characteristics are obtained, in particular, undulation and surface roughness are reduced, and superior surface accuracy is obtained. Further, the Cn or Sn alloy plating layer 316 obtains a metallic outer appearance that is close to, in particular, a Cr plating layer stacked on a bight Ni plating layer. Further, the Sn or Sn alloy plating layer 316 further facilitates fusing and deformation of the distal end 312a when coupling the ornamental plated product 310.

(4-4) In the fourth embodiment, the synthetic resin layer 317 is stacked on the Sn or Sn alloy plating layer 316 in the plating layer 314. This further improves the functionality of the surface of the ornamental plated product 310, in particular, durability such as corrosion resistance, chemical resistance, and abrasion resistance. Further, when using the transparent or translucent synthetic resin layer 317, addition of a coloring agent such as pigment or dye easily adds a color tone to the metallic outer appearance with the Sn or Sn alloy plating layer 316.

(4-5) In the fourth embodiment, it is preferred that the resin of the synthetic resin layer 317 have a glass transition temperature that is 25° C. or greater and less than or equal to the fusing-deforming temperature of the distal end 312a. This maintains the functionality of the ornamental plated product when used under room temperature, and the fusing-deforming process of the distal end 312a can be performed further easily. In other words, the practicability can be well-balanced with the productivity.

(4-6) In the fourth embodiment, it is preferred that the synthetic resin layer 317 be formed through electrodeposition painting. This allows a plating process to be performed easily and continuously from the ornamental surface 311a to the surface of the coupling portion 312 and thus further improves productivity.

The above embodiment may be modified as described below.

The application of the ornamental plated product 310 of the fourth embodiment is not particularly limited. The ornamental plated product 310 may be applied to plated products for the interior and exterior of a vehicle.

In the ornamental plated product 310 of the fourth embodiment, to improve productivity, the base 311 and coupling portion 312 excluding the distal end 312 are formed from the same resin as the distal end 312a. However, portions other than the distal end 312a may be formed from a material other than a resin that is fusible and deformable when fixing the ornamental plated product 310 to the mount 313. Specific examples of such a material include, for example, metal, glass, ceramics, and a thermosetting resin that is difficult to fuse and deform. Examples of a metal material include Al, an Al alloy, Ti, a Ti alloy, and the like.

In the fourth embodiment, the shape of the coupling portion 312 including the distal end 312a is not particularly limited and may have the form of a cylindrical post, a polygonal post, or a tube.

In the fourth embodiment, the shape of the ornamental surface 311a is not particularly limited and may be determined in accordance with the purpose of the design or the like.

In the fourth embodiment, the shape and size of the base and the shape of the coupling surface of the mount are not particularly limited and may be determined in accordance with the application and purpose of the ornamental plated product 310.

In the fourth embodiment, the number of the coupling portion 312 is not particularly limited and may be one or more taking into consideration the shape and size of the ornamental plated product 310 and the structure of the mount 313.

In the fourth embodiment, the method of fusing and deforming is not particularly limited and may be a known method such as swaging or fusing, which uses heat, ultrasonic waves, vibration, pressure, high-frequency, or the like. More specifically, ultrasonic swaging or welding may be performed.

In the fourth embodiment, when fusing and deformation occurs, there is no particular limit to the deformed shape as long as the deformation causes engagement with the coupling hole of the mount and separation from the coupling hole is restricted.

In the ornamental plated product 310 of the fourth embodiment, the same plating process is performed on the entire surface of the ornamental plated product 310 to improve productivity. However, when performing a plating process on the ornamental plated product 310 that includes a plurality of distal ends 312a, a plating process that is continuous with the ornamental surface 311a may be performed on only a portion of the distal end 312a. This structure also reduces masking processes as compared with the prior art structure and improve the productivity.

The plating layer 314 of the fourth embodiment may include portions where the plating layer thickness or plating layer structure differs as long as the desired effects are not impeded.

The present disclosure includes the examples described below.

(a) A coupling structure in which the synthetic resin layer is a polyfunctional acrylic resin layer.

(b) A coupling structure in which the ornamental plated product includes a base, a Cu plating layer that covers the base, an Sn or Sn alloy plating layer that directly contacts and covers the Cu plating layer, and an acrylic synthetic resin layer serving as a protection layer that covers the Sn or Sn alloy plating layer.

(c) An ornamental plated product including a recess in a front wall, wherein the recess has an opening width that is greater than a depth of the width.

(d) An ornamental plated product, wherein a base is free from an undercut portion at a portion where an ornamental film is formed on a base.

(e) An ornamental plated product, wherein the synthetic resin layer is a transparent or translucent layer stacked through electrodeposition painting.

(f) A method for manufacturing an ornamental plated product, wherein the electroplating step and the electrodeposition painting step includes arranging front surfaces of synthetic resin bases of a plurality of two-colored molded products in opposition with an electrode so that an interval between outer surfaces of adjacent ones of the two-colored molded products is larger than a depth dimension length of the outer surfaces of the first synthetic resin bases.

(g) The ornamental plated product is a vehicle front grille. This structure obtains a front grille having the desired functionality, such as durability, and the desired ornamentality not only in a front surface portion but also in the entire surface.

(h) A method for coupling the ornamental plated product, wherein the fused deformation is performed in a resin swaging process. This structure further facilitates the coupling step of the ornamental plated product when using a known device or the like.

(i) The ornamental plated product, wherein the plating layer is formed without performing a masking process on the distal end. This structure improves productivity particularly in a step of performing a plating process on an ornamental plated product to a step of coupling the ornamental plated product to a mount.

The embodiments and the modified examples may be combined, some of the components of an embodiment may be replaced by some of the components of the other embodiments, and some of the components of an embodiment may be added to other embodiments. For example, the plating layer and the synthetic resin layer of one of the second to fourth embodiments may cover a selected surface (for example, contact surface and/or design surface) or the entire surface of the base of the first embodiment. The plating layer and the synthetic resin layer of one of the first, third, and fourth embodiments may cover part (for example, outer surface 115, groove 116, and support 112) or all of the first synthetic resin base of the second embodiment. The plating layer and the synthetic resin layer of one of the first, second, and fourth embodiments may entirely cover the base of the third embodiment. The plating layer and the synthetic resin layer of one of the first to third embodiments may cover a selected surface (for example, distal end of coupling portion) or the entire surface of the base of the fourth embodiment. The structure of the bases in the embodiments may be changed or combined. For example, the bases of the first to third embodiments may include the coupling portion 312 of the fourth embodiment. The bases of the first, third, and fourth embodiment may be two-color molded products. The advantages of such replacements and/or additions should be apparent to those skilled in the art from the disclosure of the specification and drawings of the present application.

The present invention is not limited to the exemplified examples. For example, the exemplified features should not be understood as being essential to the present invention, and the subject matter of the present invention may exist in fewer features than all features of a certain one of the disclosed embodiments.

### DESCRIPTION OF REFERENCE CHARACTERS

1, 102, 210, 310) ornamental plated product; 1a, 102a, 311) base; 1b, 121, 122, 214, 215, 314, 315, and 316) plating layer; 1c, 123, 216, 317) synthetic resin layer; 2, 3) coupling component; 4, 313) mount, 113) front surface; 117) boundary; 211) horizontal bar; 211c) recess; 311a) ornamental portion; 312) coupling portion; 312a) distal end of coupling portion.

1. An ornamental plated product for use with a metal coupling member, wherein the ornamental plated product comprises:
a base including a contact portion shaped to be engageable with the metal coupling member;
at least one plating layer that covers the base and includes a metal that differs from a metal included in the metal coupling member; and
a synthetic resin layer that covers the plating layer where at least the contact portion is located.

2. The ornamental plated product according to claim 1, wherein:
the base includes a design surface that differs from the contact portion,
the plating layer covers the design surface and the contact portion of the base, and
the synthetic resin layer is a transparent or translucent synthetic resin layer that integrally covers the plating layer on the design surface and the contact portion of the base.

3. The ornamental plated product according to claim 1, wherein the synthetic resin layer is an electrodeposition paint composition or a hardened electrodeposition paint composition.

4. The ornamental plated product according to claim 1, wherein the plating layer is a plurality of metal plating layers selected from an Ni plating layer, a Cu plating layer, a Cr plating layer, an Sn plating layer, and an Sn alloy plating layer.

5. The ornamental plated product according to claim 1, wherein the plating layer includes an outermost plating layer that is an Sn or Sn alloy layer.

6. The ornamental plated product according to claim 1, wherein the ornamental plated product is an ornamental product for a vehicle.

7. A coupling structure comprising:
the ornamental plated product according to claim 1; and
a metal coupling member configured to engage the contact portion of the ornamental plated product and fix the ornamental plated product to a mount.

8. An ornamental plated product comprising:
a base;
a plating layer that covers the base; and
a synthetic resin layer that covers the plating layer; wherein
the base is an integrated two-color molded product of a first synthetic resin base and a second synthetic resin base,
the plating layer includes a metal plating layer that entirely covers only a selected surface of the first synthetic resin base, and
the synthetic resin layer includes an electrodeposition paint composition or a hardened electrodeposition paint composition.

9. The ornamental plated product according to claim 8, further comprising a boundary between the first synthetic resin base and the second synthetic resin base.

10. The ornamental plated product according to claim 8, wherein the plating layer includes an outermost plating layer that is an Sn or Sn alloy layer.

11. The ornamental plated product according to claim 8, wherein the ornamental plated product is an ornamental product for a vehicle.

12. A method for manufacturing an ornamental plated product, the method comprising:
electroless plating to form an electroless plating layer that entirely covers only a selected surface of a first synthetic resin base in a two-color molded synthetic resin base;
electroplating to form a metal plating layer on the electroless plating layer; and
electrodeposition painting to form a synthetic resin layer on the metal plating layer.

13. The method for manufacturing an ornamental plated product according to claim 12, wherein the electrodeposition painting irradiates ultraviolet rays and hardens a resin film to form the synthetic resin layer.

14. The method for manufacturing an ornamental plated product according to claim 12, wherein:
the electroplating forms the metal plating layer on a plurality of two-color molded products at the same time;
the electrodeposition painting forms the synthetic resin layer on the plurality of two-color molded products, on which the metal plating layer has been formed, at the same time; and
the plurality of two-color molded products are arranged next to one another so that a front surface of the first synthetic resin base of each of the plurality of two-color molded products is opposed to an electrode in the electroplating and the electrodeposition painting.

15. An ornamental plated product comprising:
a base and a plating layer that covers the base; wherein
the base has a ladder structure, a grid structure, or a multiple-recess structure,
the plating layer includes
a metal plating layer that covers an entire surface of the base and has a thickness of 0.03 μm or greater, and
a transparent or translucent synthetic resin layer that covers the metal plating layer and includes an electrodeposition paint composition or a hardened electrodeposition paint composition.

16. The ornamental plated product according to claim 15, wherein the synthetic resin layer has a thickness of 5 μm or greater.

17. The ornamental plated product according to claim 15, wherein the metal plating layer includes at least one selected from Ni, Cu, Cr, Sn, and Sn alloy.

18. The ornamental plated product according to claim 15, wherein the base metal plating layer has a thickness profile including a first thickness at a first portion of the base and a second thickness, which differs from the first thickness, at a second portion of the base.

19. The ornamental plated product according to claim 15, wherein the metal plating layer includes an outermost plating layer that is an Sn or Sn alloy layer.

20. The ornamental plated product according to claim 15, wherein the ornamental plated product is an ornamental product for a vehicle.

21. An ornamental plated product comprising:
a base and a plating layer that covers the base to provide the base with an ornamental portion; wherein
the base includes a coupling portion that differs from the ornamental portion, wherein the coupling portion is configured to be coupled to a mount, and the coupling portion includes a distal end formed from a fusible and deformable resin for engagement in a fixed manner with the mount,
the plating layer includes a Cu plating layer that covers the base, an Sn or Sn alloy layer that directly contacts and covers the Cu plating layer, and a synthetic resin layer that covers the Sn or Sn alloy plating layer, and
the plating layer that provides the ornamental portion continuously extends from at least a surface of the distal end of the coupling portion.

22. The ornamental plated product according to claim 21, wherein the synthetic resin layer includes an electrodeposition paint composition or a hardened electrodeposition paint composition.

23. The ornamental plated product according to claim 21, wherein the synthetic resin layer is formed from a resin having a glass transition temperature of 25° C. or greater and a fusing-deforming temperature that is less than or equal to that of the distal end.

24. The ornamental plated product according to claim 21, wherein the ornamental plated product is an ornamental product for a vehicle.

25. A method for coupling an ornamental plated product to a mount, the method comprising:
fixing the ornamental plated product according to claim 21 to the mount by fusing and deforming the distal end of the coupling portion, which is covered by the plating layer, in a state engaged with the mount.
